(19) United States
(12) Patent Application Publication
(10) Pub. No.: US 2023/0290961 A1
(43) Pub. Date: Sep. 14, 2023

(54) REDUCING BUBBLE ACCUMULATION ON ELECTRODES, AND RELATED ARTICLES AND SYSTEMS

(71) Applicant: Massachusetts Institute of Technology, Cambridge, MA (US)

(72) Inventors: Kripa K. Varanasi, Lexington, MA (US); John Lake, Cambridge, MA (US)

(73) Assignee: Massachusetts Institute of Technology, Cambridge, MA (US)

(21) Appl. No.: 18/007,891

(22) PCT Filed: Jun. 2, 2021
(86) PCT No.: PCT/US2021/035354

§ 371 Date: Dec. 2, 2022

Related U.S. Application Data
(60) Provisional application No. 63/034,013, filed on Jun. 3, 2020.

(51) Int. Cl. H01M 4/70

(52) U.S. Cl. CPC H01M 4/70; H01M 2004/021

(57) ABSTRACT

Disclosed herein are methods for reducing bubble accumulation on electrodes. Related articles (e.g., electrodes or electrochemical cells) and systems are also described herein.

### RELATED APPLICATIONS

This application claims priority under 35 U.S.C. § 119(e) to U.S. Provisional Pat. Application No. 63/034,013, filed Jun. 3, 2020, which is hereby incorporated by reference in its entirety.

### TECHNICAL FIELD

Reducing bubble accumulation on electrodes, and related articles and systems, are generally described.

### SUMMARY

Disclosed herein are methods for reducing bubble accumulation on electrodes. Related articles (e.g., electrodes or electrochemical cells) and systems are also described herein. In some embodiments, the electrode comprises an electroactive surface. The electroactive surface, in certain embodiments, comprises a surface texture. In certain instances, the surface texture comprises a plurality of microscale protrusions and/or a plurality of microscale indentations. In some cases, the surface texture is configured to reduce the median size of bubbles produced during a gas-generating reaction and/or reduce the total surface area of the electroactive surface covered by bubbles produced during a gas-generating reaction. In certain embodiments, the surface texture is configured to reduce the accumulation of bubbles such that electrochemical output is increased (e.g., current density is increased). The subject matter of the present invention involves, in some cases, interrelated products, alternative solutions to a particular problem, and/or a plurality of different uses of one or more systems and/or articles.

Certain aspects are related to electrodes. In some embodiments, the electrode comprises an electroactive surface comprising a surface texture, wherein the surface texture is configured such that, during a gas-generating reaction in a liquid medium adjacent to the electroactive surface, the median size of bubbles produced during the reaction and/or the total surface area of the electroactive surface covered by bubbles produced during the reaction are reduced relative to the median size of bubbles produced on an electrode lacking the surface texture but under otherwise identical conditions and/or the total surface area of the electroactive surface covered by bubbles produced on an electrode lacking the surface texture but under otherwise identical conditions.

Certain aspects are related to electrochemical devices. In certain embodiments, the electrochemical device comprises a first electrode; a second electrode; and a liquid electrolyte between the first electrode and the second electrode; wherein at least one of the first electrode and the second electrode comprises an electroactive surface comprising a surface texture that reduces the median size of bubbles produced during a gas-generating reaction within the electrochemical device and/or reduces the total surface area of the electroactive surface covered by bubbles produced during a gas-generating reaction within the electrochemical device.

Certain aspects are related to methods. In some embodiments, the method comprises running a gas-generating reaction within an electrochemical device disclosed herein. In certain embodiments, the method comprises running a gas-generating reaction with an electrode disclosed herein.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is, in accordance with some embodiments, an electrode.

FIG. 2 is, in accordance with some embodiments, an electrochemical cell.

FIG. 3A is, in accordance with some embodiments, a cross-section of an electroactive surface comprising a surface texture comprising a plurality of microscale protrusions with a square shape in the XY-Plane.

FIG. 3B is, in accordance with some embodiments, a side view of the electroactive surface of FIG. 3A.

FIG. 3C is, in accordance with some embodiments, a cross-section of an electroactive surface comprising a surface texture comprising a plurality of microscale protrusions with a circular shape in the XY-Plane.

FIG. 3D is, in accordance with some embodiments, a surface texture comprising a plurality of microscale protrusions and a solid fraction larger than that shown in FIG. 3E.

FIG. 3E is, in accordance with some embodiments, a surface texture comprising a plurality of microscale protrusions and a solid fraction smaller than that shown in FIG. 3D.

FIG. 3F is, in accordance with some embodiments, examples of possible shapes for microscale protrusions and/or microscale indentations.

FIG. 3G is, in accordance with some embodiments, a cross-section of an electroactive surface comprising a surface texture comprising a plurality of microscale indentations.

FIG. 3H is, in accordance with some embodiments, a side view of the electroactive surface of FIG. 3G.

FIG. 3I is, in accordance with some embodiments, a surface texture comprising a plurality of microscale indentations and a solid fraction larger than that shown in FIG. 3J.

FIG. 3J is, in accordance with some embodiments, a surface texture comprising a plurality of microscale indentations and a solid fraction smaller than that shown in FIG. 3I.

FIG. 4 is a schematic showing the equilibrium contact angle of a bubble on a flat surface (θ_{w}).

FIG. 5A shows the evolution/coevolution of bubbles on an electrode surface.

FIG. 5B shows the evolution/coevolution of bubbles on a porous electrode, where bubbles can become trapped, flooding the active area.

FIG. 6 is a schematic of a bubble formed from nucleate gas evolution over its lifetime. It shows that after nucleation, a bubble grows to a critical size, then it departs the electrode surface and another bubble is nucleated and grows again.

FIG. 7 is a schematic of bubbles formed from nucleate gas evolution interacting with one another on the surface of an electrode. It shows how neighboring bubbles can come into contact, resulting in coalescence, and then they can depart the surface or continue to grow prior to departing the surface.

FIG. 8 is a diagram showing the electrochemical evolution of gas products conceptually.

FIG. 9 is a circuit diagram showing the three-electrode experimental arrangement used for the experiments described in Example 1.

FIGS. 10A-10C are images showing the experimental setups used in the example. FIG. 10A is a diagram of the setup used for initial observations and proof of concept experiments. FIG. 10B is an image of the setup used for current and bubble response measurements. FIG. 10C is an image of the setup used for cyclic voltammetry and bubble visualization from above.

FIGS. 11A-11B are a circuit diagram and data related to a chronoamperometry experiment. FIG. 11A is a schematic of a chronoamperometry experiment, where the current was measured over time for a controlled voltage. FIG. 11B is an illustrative result of the data collected in the example, where the current trace is shown over time and the voltage was controlled to a constant value throughout.

FIGS. 12A-12B are a circuit diagram and data related to a chronopotentiometry experiment. FIG. 12A is a schematic of a chronopotentiometry experiment, where the voltage was measured over time for a controlled current. FIG. 12B is an illustrative result of the data collected, where the voltage trace is shown over time, and the current was controlled to a constant value throughout.

FIGS. 13A-13B are schematics of a cyclic voltammetry experiment done with a linear sweep potential at a constant scan rate. FIG. 13A is a graph showing the potential as a function of time as the potential was controlled and swept at a linear rate forward, then at the same rate backward. FIG. 13B is a graph showing the current as a function of time as the resulting current was measured as a function of applied potential over the single cycle throughout the sweeping of potential.

FIG. 14 is an illustrative example of the trace of the data collected during a cyclic voltammetry experiment.

FIG. 15 is a diagram of static force balance for an idealized bubble on the surface of an electrode.

FIGS. 16A-16B are a schematic and an image of the microscale protrusions used for experiments. FIG. 16A shows the geometry of the microscale protrusions used: square pillars with side lengths a, heights of h, and spacing between posts b were used. FIG. 16B is a scanning electron microscope image of an illustrative example of an actual surface used.

FIG. 17 is a schematic of various surface textures before and after sputtering with a platinum catalyst, according to some embodiments.

FIG. 18 is a diagram of a top view of a square surface texture unit cell, according to some embodiments. Each microscale protrusion is spaced by b, with square tops of side length a, and height h into the page.

FIGS. 19A-19C are images from the initial observations of the effects of changing the surface texture of an electrode’s electroactive surface, according to some embodiments. Each image was taken at the same time after the start of a chronoamperometry experiment using E= -1.1 V vs Ag/AgCl. Scale bar is 5 mm. The surface texture in FIG. 19A had a 5 micron median spacing, and it had the largest bubbles, which covered the vast majority of the electrode’s electroactive surface. The surface texture in FIG. 19B had a 10 micron median spacing, with smaller bubbles than in FIG. 19A, and less coverage of the electrode’s electroactive surface. FIG. 19C had a 25 micron median spacing, with smaller bubbles than both FIG. 19A and FIG. 19B, and less coverage of the electrode’s electroactive surface than in FIG. 19A.

FIG. 20 is a set of chronoamperometry data collected for initial observations. The initial observations images were taken at 80 seconds for each case. The current density was derived using the geometric area of the surface texture.

FIG. 21 is a set of data showing results from cyclic voltammetry determination of the adsorbed charge, comparing relative charge to relative surface area based on the surface texture geometries.

FIG. 22 is a graph showing the strong linear correlation between the relative geometric surface area and relative adsorbed charge, according to some embodiments, indicating that the entire surface of the textures is electrochemically active.

FIGS. 23A-23B are data sets showing the results from chronopotentiometry experiments, using a constant current density of 1 mA/cm2 for various textures, based on their geometric surface area. FIG. 23A shows the potential over time, whereas FIG. 23B shows the potential at 60 seconds.

FIGS. 24A-24B are images showing a comparison of the view of the electrode’s surface after 360 seconds into the chronoamperometry experiment. Scale bars in both images are 3 mm. FIG. 24A is an electrode with a median spacing of 20 microns while FIG. 24B is an electrode with a median spacing of 5 microns.

FIGS. 25A-25B are data sets, according to some embodiments, showing the results from chronoamperometry experiments on microscale protrusion textures and the control surface. FIG. 25A shows the potential over time, whereas FIG. 25B shows the potential at 360 seconds.

FIG. 26 is an image showing the experimental setup used for capturing images of bubble evolution from the electrode’s surface from above using a microscope, and the top microscope view of bubbles on an electrode.

FIGS. 27A-27B are images showing a comparison of the distribution of bubbles on the surface of an electrode’s surface during chronoamperometry experiments after 20 seconds. FIG. 27A is the control while FIG. 27B has a median spacing of 25 microns.

FIGS. 28A-28C are side view images showing the electrochemical cell used for visualizing bubble evolution. FIG. 28A is the conceptual electrochemical cell, FIG. 28B is the modeled electrochemical cell, and FIG. 28C is the prototype electrochemical cell.

FIG. 29 is a top view image of the electrochemical cell used for visualizing bubble evolution.

FIG. 30 is a plot of current versus time for electrochemical cells with electrodes comprising microscale surface texture, nanoscale surface texture, or no surface texture.

FIG. 31 is a plot of current versus time for electrochemical cells with electrodes comprising microscale texture with various spacings versus a control.

FIG. 32 shows current standard deviation for electrochemical cells with electrodes comprising microscale texture with various spacings versus a control.

FIG. 33 shows active area and relative area versus control for electrochemical cells with electrodes comprising microscale texture with various spacings.

FIG. 34 shows the average current for various applied overpotentials (vs RHE) for electrodes comprising microscale texture with various spacings versus a control.

FIG. 35 is a schematic that demonstrates the difference in the size of the contact line in systems with varying surface texture or no surface texture.

### DETAILED DESCRIPTION

Disclosed herein are methods for reducing bubble accumulation on electrodes. Related articles (e.g., electrodes or electrochemical cells) and systems are also described herein. Many electrochemical reactions generate gas (which can manifest as bubbles), either as the desired product or as a side-product. In many such systems, the generated bubbles are pinned to the electroactive surface as they grow, reducing the surface area of the electroactive surface that can participate in the electrochemical reaction, resulting in decreased electrochemical output, kinetic losses (e.g., due to blockage of the catalyst on the electroactive surface), and/or ohmic losses. Moreover, after the pinned bubbles grow to a certain size, they are frequently released from the electroactive surface, resulting in a sudden increase in the surface area of the electroactive surface that can participate in the electrochemical reaction, resulting in inconsistent electrochemical output during the electrochemical reaction. In some embodiments, the articles, systems, and/or methods described herein reduce the median size (e.g., diameter) of these bubbles and/or the total surface area of the electroactive surface covered by bubbles during these electrochemical reactions.

For example, in certain embodiments, an electrode comprises an electroactive surface comprising a surface texture. In certain instances, the surface texture comprises a plurality of microscale protrusions and/or a plurality of microscale indentations. In some cases, the size (e.g., smallest cross-sectional dimension and/or height), shape, spacing, and/or solid fraction of the microscale protrusions and/or microscale indentations can be selected to reduce the median size (e.g., diameter) of the bubbles produced during electrochemical reactions and/or the total surface area of the electroactive surface covered by bubbles produced during electrochemical reactions, which can affect, in some instances, the electrochemical output, the consistency of the electrochemical output, and/or the current density. In some embodiments, one or more of these advantages can be achieved solely by changing the texture of the electroactive surface, without any changes to the chemistry of the electroactive surface.

In certain embodiments, the median size (e.g., diameter) of bubbles produced during the electrochemical reaction is reduced by at least 10%, at least 20%, at least 30%, at least 40%, or at least 50% compared to the median size (e.g., diameter) of bubbles produced during an identical electrochemical reaction with an otherwise identical electrode that does not comprise the surface texture. In some embodiments, the median size (e.g., diameter) of bubbles produced during the electrochemical reaction is reduced by up to 95%, up to 98%, up to 99%, or more. Combinations of these ranges are also possible (e.g., at least 10% and up to 99%).

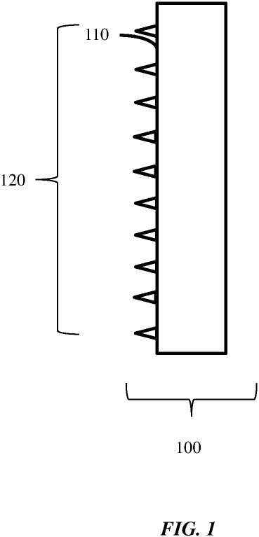

Articles are described herein. Some such articles are illustrated schematically in FIGS. 1-3. In some embodiments, the article comprises an electrode. In certain embodiments, the electrode comprises an electroactive surface. For example, in accordance with certain embodiments, electrode 100 in FIG. 1 comprises electroactive surface 110. In some cases, the electroactive surface comprises a surface texture. For example, in accordance with some embodiments, electroactive surface 110 in FIG. 1 comprises surface texture 120. In some cases, the surface texture is applied to solid surface(s) of a porous electrode. For example, for a porous electrode made up of a collection of fibers, surface texture may be applied to the individual fibers, in certain instances. A person of ordinary skill in the art would be capable of distinguishing between the indentations described herein and pores because pores form an interconnected network of fluidically accessible channels, while indentations as used herein refer to discrete indentations into a surface that are not fluidically connected to each other.

In certain instances, the surface texture is configured such that, during a gas-generating reaction in a liquid medium adjacent to the electroactive surface, the median size of bubbles produced during the reaction and/or the total surface area of the electroactive surface covered by bubbles produced during the reaction are reduced relative to the median size of bubbles produced on an electrode lacking the surface texture but under otherwise identical conditions and/or the total surface area of the electroactive surface covered by bubbles produced on an electrode lacking the surface texture but under otherwise identical conditions. For example, in some cases, the surface texture is configured such that, during a gas-generating reaction in a liquid medium directly contacting the electroactive surface, the median size of bubbles produced during the reaction and/or the total surface area of the electroactive surface in direct contact with bubbles produced during the reaction are reduced relative to the median size of bubbles produced during an identical gas-generating reaction in an identical liquid medium adjacent to the electroactive surface of an electrode lacking the surface texture but otherwise identical and/or the total surface area of the electroactive surface covered by bubbles produced during an identical gas-generating reaction in an identical liquid medium adjacent to the electroactive surface of an electrode lacking the surface texture but otherwise identical. In some embodiments, the liquid medium comprises any liquid electrolyte described herein.

In some embodiments, the surface texture reduces the median size of bubbles produced during a gas-generating reaction (e.g., within an electrochemical device described herein) and/or reduces the total surface area of the electroactive surface covered by bubbles produced during a gas-generating reaction (e.g., within an electrochemical device described herein).

In some embodiments, the surface texture comprises protrusions and/or indentations. In certain cases, the protrusions and/or indentations are microscale.

As used herein, a microscale feature (e.g., a microscale protrusion and/or microscale indentation) has at least one cross-sectional dimension, at the surface from which the feature is formed, that is greater than or equal to 1 micron and less than or equal to 1,000 microns. In some embodiments, a microscale feature comprises two orthogonal cross-sectional dimensions, at the surface from which the feature is formed, that are each greater than or equal to 1 micron and less than or equal to 1,000 microns. In certain embodiments, the microscale features have a maximum cross-sectional dimension, at the surface from which the feature is formed, that is greater than or equal to 1 micron and less than or equal to 1,000 microns.

In contrast, as used herein, a nanoscale feature has at least one cross-sectional dimension, at the surface from which the feature is formed, that is greater than or equal to 10 nm and less than 1 micron, and no cross-sectional dimension of greater than or equal to 1 micron and less than or equal to 1,000 microns. In some embodiments, a nanoscale feature comprises two orthogonal cross-sectional dimensions, at the surface from which the feature is formed, that are each greater than or equal to 10 nm and less than 1 micron. In certain embodiments, the nanoscale features have a maximum cross-sectional dimension, at the surface from which the feature is formed, that is greater than or equal to 1 nanometer and less than or equal to 1,000 nanometers.

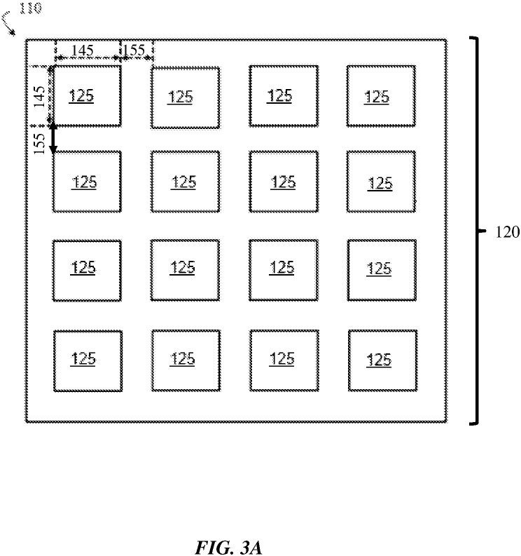

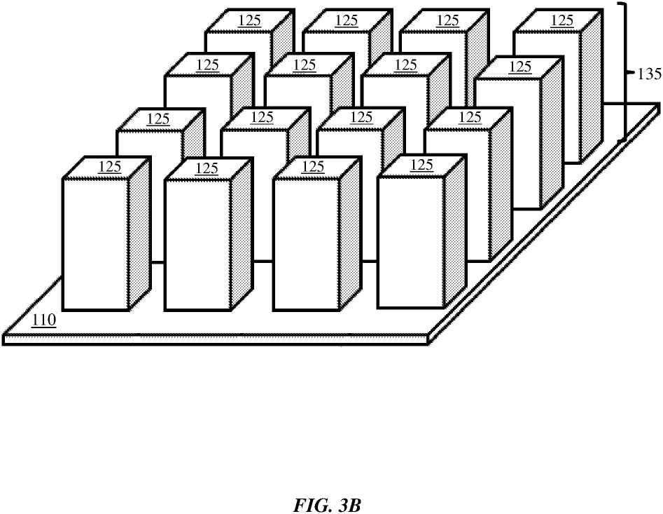

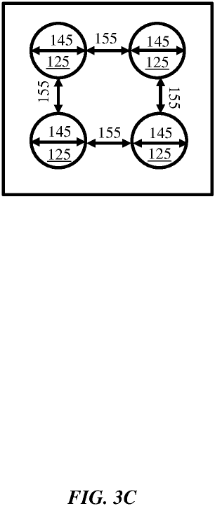

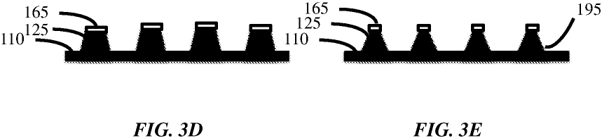

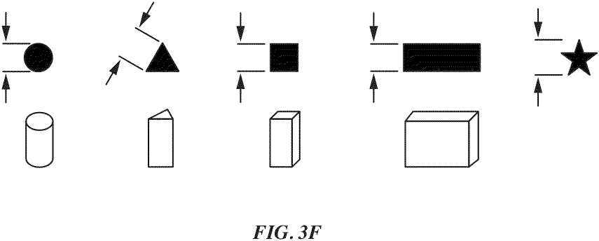

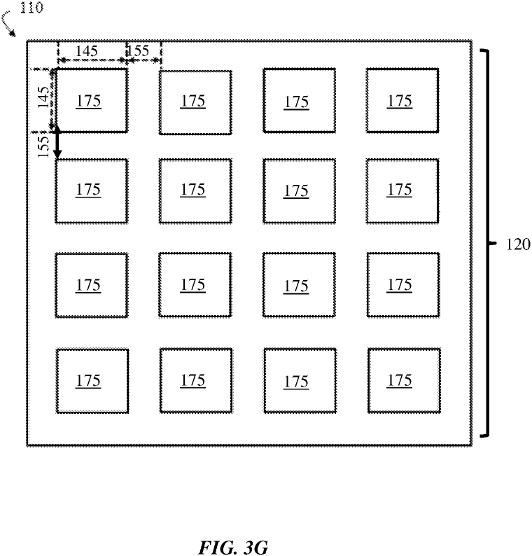

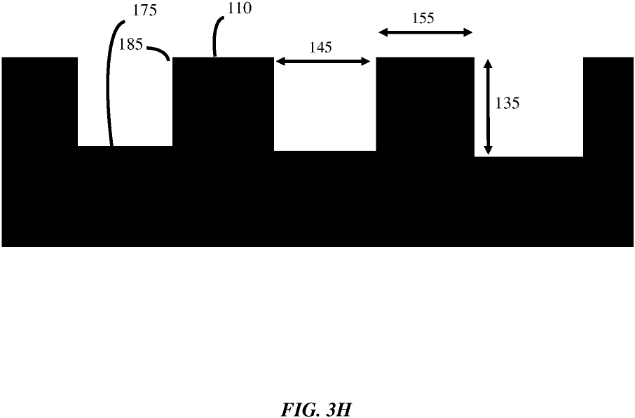

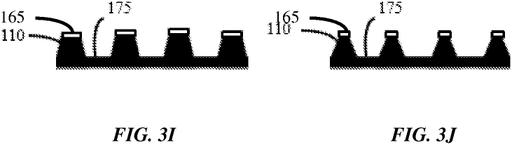

When measuring a cross-sectional dimension to determine whether or not a feature is a microscale feature and to determine whether or not a feature is a nanoscale feature, the cross-sectional dimension is measured parallel to the surface from which the feature is formed, from one end of the feature to an opposing end, and through the geometric center of the section being measured (which may or may not be the geometric center of the feature as a whole). In the case of a protrusion, the surface from which the feature is formed is located at the base of the protrusion. That is to say, in the case of a protrusion the surface from which the feature is formed is the surface from which the protrusion extends. For example, in accordance with certain embodiments, in FIG. 3E, top surface 195 is the surface from which protrusions 125 extend, and therefore, top surface 195 is the surface from which protrusions 125 are formed. In the case of an indentation, the surface from which the feature is formed is the top surface into which the indentation extends. For example, in accordance with some embodiments, in FIG. 3H, top surface 185 is the surface into which the indentations extend and therefore, top surface 185 is the surface from which indentations 175 are formed.

In some instances, a microscale feature (e.g., a microscale protrusion and/or microscale indentation) comprises nanoscale features (e.g., nanoscale protrusions and/or nanoscale indentations) (e.g., on a top surface). The physical characteristics of the surface texture (e.g., surface roughness, spacing, height, smallest cross-sectional dimension, and/or surface fraction) may be measured using a variety of available profilometry techniques (e.g., optical profilometry, mechanical profilometry, atomic force microscopy).

In certain embodiments, the surface texture comprises a plurality of microscale protrusions. For example, in accordance with some embodiments, surface texture 120 in FIG. 3A comprises microscale protrusions 125. In some embodiments, the microscale protrusions are uniform. In certain cases, the microscale protrusions are not uniform (e.g., if they are applied via spray or deposition).

The microscale protrusions may have a variety of suitable shapes, in some cases. Non-limiting examples of suitable shapes for microscale protrusions are shown in FIG. 3F. In some embodiments, the electroactive surface defines the XY-plane. In solid black, FIG. 3F shows a cross-section in the XY-plane of examples of suitable shapes. For example, FIG. 3F shows cross-sections in the XY-plane in the shape of (from left to right): a circle, a triangle, a square, a rectangle, and a star. In some embodiments, convex geometries (e.g., a star) reduce pinning distances, resulting in a reduction in median bubble size and/or the total surface area of the electroactive surface covered by bubbles. As used herein, a convex shape is a shape that includes at least some empty space relative to its convex hull. As a person of ordinary skill in the art would understand, a convex hull may be visualized as the shape enclosed by a rubber band stretched around the vertices of the shape.

In certain embodiments, the microscale protrusions have a smallest cross-sectional dimension within a particular range. The microscale protrusions may also have a height within a particular range. As used herein, the smallest cross-sectional dimension of a microscale protrusion is the smallest dimension of the microscale protrusion in a direction parallel to the surface from which the microscale protrusion extends (i.e., the smallest dimension in a direction in the XY-plane as illustrated in the figures) measured through the geometric center of the section being measured (which may or may not be the geometric center of the microscale protrusion as a whole). For example, in the case of a pyramidal protrusion, the smallest cross-sectional dimension is the cross-sectional dimension of the tip of the pyramid measured through the geometric center of the tip of the pyramid.

Also, as used herein, the height of a microscale protrusion corresponds to the largest cross-sectional dimension in a direction perpendicular to the surface from which the microscale protrusion extends (i.e., the largest cross-sectional dimension of the microscale protrusion in the Z-direction as illustrated in the figures, where the Z-direction is perpendicular to the XY-plane). Accordingly, the height cannot be the smallest cross-sectional dimension. For example, in accordance with certain embodiments, microscale protrusions 125 in FIG. 3A have smallest cross-sectional dimension 145 in the XY-plane, while microscale protrusions 125 in FIG. 3B have height 135 in the Z-direction. The arrows in FIG. 3F demonstrate the smallest cross-sectional dimensions for various shapes.

In certain instances, the smallest cross-sectional dimension of the microscale protrusions is uniform. In some embodiments, the smallest cross-sectional dimension of the microscale protrusions is not uniform. In certain embodiments, the microscale protrusions have a median smallest cross-sectional dimension of less than or equal to 1.0 times, less than or equal to 0.9 times, less than or equal to 0.8 times, less than or equal to 0.7 times, or less than or equal to 0.6 times the median bubble size produced during use in an otherwise identical system without the microscale protrusions. In some embodiments, the microscale protrusions have a median smallest cross-sectional dimension of greater than or equal to 0.1 times, greater than or equal to 0.2 times, greater than or equal to 0.3 times, or greater than or equal to 0.4 times the median bubble size produced during use in an otherwise identical system without the microscale protrusions. Combinations of these ranges are also possible (e.g., greater than or equal to 0.1 times the median bubble size produced during use and less than or equal to the median bubble size produced during use in an otherwise identical system without the microscale protrusions).

In certain embodiments, the microscale protrusions have a median smallest cross-sectional dimension of less than or equal to 1,000 microns, less than or equal to 800 microns, less than or equal to 600 microns, less than or equal to 400 microns, less than or equal to 200 microns, or less than or equal to 100 microns. In some embodiments, the microscale protrusions have a median smallest cross-sectional dimension of greater than or equal to 1 micron, greater than or equal to 2 microns, greater than or equal to 4 microns, greater than or equal to 6 microns, greater than or equal to 8 microns, or greater than or equal to 10 microns. Combinations of these ranges are also possible (e.g., greater than or equal to 1 micron and less than or equal to 1,000 microns or greater than or equal to 10 microns and less than or equal to 100 microns).

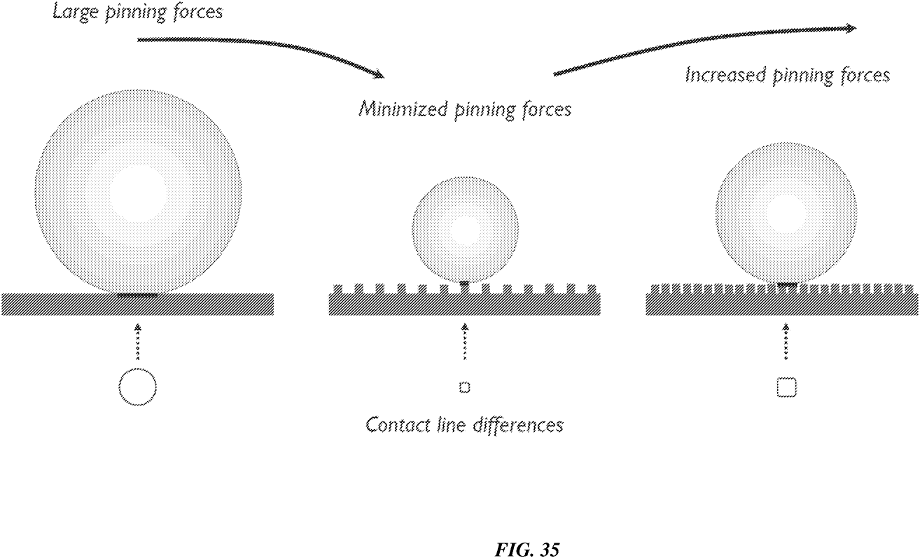

In some embodiments, the microscale protrusions are pinning sites for the growth of bubbles, such that having a smaller cross-sectional dimension results in a reduced median bubble size. For example, in FIG. 35, the pinning site/contact line is smaller for a surface with microscale protrusions (middle) than a surface without microscale protrusions (left), in some cases, as the microscale protrusions serve as the pinning sites/contact lines for the growth of bubbles.

In some embodiments, the height of the microscale protrusions is uniform. In certain cases, the height of the microscale protrusions is not uniform. In some instances, the microscale protrusions have a median height of greater than or equal to 0.1 times, greater than or equal to 0.2 times, greater than or equal to 0.3 times, greater than or equal to 0.4 times, or greater than or equal to 0.5 times the median smallest cross-sectional dimension of the microscale protrusions. In accordance with certain embodiments, the microscale protrusions have a median height of less than or equal to 10 times, less than or equal to 8 times, less than or equal to 6 times, less than or equal to 4 times, or less than or equal to 2 times the median smallest cross-sectional dimension of the microscale protrusions. Combinations of these ranges are also possible (e.g., greater than or equal to 0.1 times the median smallest cross-sectional dimension of the microscale protrusions and less than or equal to 10 times the median smallest cross-sectional dimension of the microscale protrusions or greater than or equal to 0.5 times the median smallest cross-sectional dimension of the microscale protrusions and less than or equal to 2 times the median smallest cross-sectional dimension of the microscale protrusions).

In some instances, the microscale protrusions have a median height of greater than or equal to 1 micron, greater than or equal to 10 microns, greater than or equal to 50 microns, greater than or equal to 100 microns, greater than or equal to 200 microns, greater than or equal to 300 microns, greater than or equal to 400 microns, or greater than or equal to 500 microns. In certain cases, the microscale protrusions have a median height of less than or equal to 1,000 microns, less than or equal to 800 microns, less than or equal to 600 microns, less than or equal to 400 microns, or less than or equal to 200 microns. Combinations of these ranges are also possible (e.g., greater than or equal to 1 micron and less than or equal to 1,000 microns, greater than or equal to 1 micron and less than or equal to 200 microns, or greater than or equal to 500 microns and less than or equal to 1,000 microns). In certain embodiments, an increase in height can lead to increased electrochemical output (e.g., if the microscale protrusion is coated in a catalyst) because it increases surface area.

Generally, the microscale protrusions have spacing between them. As used herein, the spacing between two features (e.g., microscale protrusions and/or microscale indentations) is the nearest neighbor distance. The nearest neighbor distance is the closest distance possible between the top surface of a feature and the top surface of the nearest feature (e.g., from the edge of the top surface of a rectangular prism-shaped protrusion to the closest edge of the top surface of the nearest rectangular prism-shaped protrusion). As used herein, the top surface of a microscale protrusion is the highest surface of the microscale protrusion, whereas the top surface of a microscale indentation is where the microscale indentation meets the electroactive surface. In some embodiments, the spacing between two features is the same as the distance between the geometric center of a feature and the geometric center of the nearest neighbor feature (e.g., in the case of pyramidal protrusions). In certain cases, the spacing between two features is not the same as the distance between the geometric center of a feature and the geometric center of the nearest neighbor feature (e.g., in the case of rectangular prism-shaped protrusions). For example, in accordance with certain embodiments, microscale protrusions 125 in FIG. 3A have spacing 155 between them. Similarly, in accordance with some embodiments, microscale protrusions 125 in FIG. 3C have spacing 155 between them. In some instances, the spacing between the microscale protrusions is uniform. In certain cases, the spacing between the microscale protrusions is not uniform. The spacing may be measured using a variety of available profilometry techniques (e.g., optical profilometry, mechanical profilometry, atomic force microscopy).

In some embodiments, the median spacing between the microscale protrusions is greater than or equal to 0.05 times, greater than or equal to 0.1 times, greater than or equal to 0.2 times, greater than or equal to 0.3 times, greater than or equal to 0.4 times, or greater than or equal to 0.5 times the median smallest cross-sectional dimension of the microscale protrusions. In certain embodiments, the median spacing between the microscale protrusions is less than or equal to 10 times, less than or equal to 8 times, less than or equal to 5 times, less than or equal to 2 times, or less than or equal to 1 time the median smallest cross-sectional dimension of the microscale protrusions. Combinations of these ranges are also possible (e.g., greater than or equal to 0.05 times and less than or equal to 10 times or greater than or equal to 0.5 times and less than or equal to 1 time the median smallest cross-sectional dimension of the microscale protrusions).

In some cases, the median spacing between the microscale protrusions is greater than or equal to 0.05 microns, greater than or equal to 0.1 microns, greater than or equal to 0.5 microns, greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, or greater than or equal to 10 microns. In certain cases, the median spacing between microscale protrusions is less than or equal to 10,000 microns, less than or equal to 8,000 microns, less than or equal to 6,000 microns, less than or equal to 4,000 microns, less than or equal to 2,000 microns, less than or equal to 1,000 microns, less than or equal to 500 microns, less than or equal to 100 microns, less than or equal to 75 microns, less than or equal to 50 microns, or less than or equal to 40 microns. Combinations of these ranges are also possible (e.g., greater than or equal to 0.05 microns and less than or equal to 10,000 microns, greater than or equal to 0.5 microns and less than or equal to 10,000 microns, or greater than or equal to 5 microns and less than or equal to 40 microns).

In certain embodiments, if the median spacing between the microscale protrusions is too small, multiple microscale protrusions can serve as pinning sites for the same bubble, such that the bubble can grow larger in size than if the microscale protrusions had a higher spacing. For example, in FIG. A, when the spacing between the microscale protrusions is decreased (right), multiple microscale protrusions serve as pinning sites/contact lines for the same bubble, resulting in a larger pinning site/contact line than for a similar system with greater spacing (middle), in some cases. In some embodiments, if the median spacing between the microscale protrusions is too large, the bubbles have a larger pinning site between the microscale protrusions, such that bubbles can grow larger in size than if the microscale protrusions had a smaller spacing.

In some embodiments, the microscale protrusions are coated with a catalyst (e.g., for the desired electrochemical reaction). In certain embodiments, the smaller the median spacing between the microscale protrusions, the more catalyst will be present, resulting in increased electrochemical output. However, as described above, in some embodiments, if the median spacing is too small, the bubble size is larger than it would be with a higher median spacing, which can result in a lower electrochemical output. Thus, in some cases, the median spacing is configured to provide a higher current density, where current density is the electrochemical output divided by the surface area coated with catalyst.

In certain embodiments, the surface texture comprising a plurality of microscale protrusions has a solid fraction within a particular range. As used herein, the solid fraction (Ø) is the combined surface area of the top surface of all microscale features divided by the surface area of the electroactive surface if there were no microscale features and it was flat. In the case of microscale protrusions, the combined surface area of the top surface of all microscale features is the combined surface area of the top surface of all of the microscale protrusions. In the case of microscale indentations, the combined surface area of the top surface of all microscale features is the combined surface area of the electroactive surface that is not occupied by the microscale indentations. For example, if an electroactive surface had nanoscale protrusions, but no microscale features, then the solid fraction would be 1, because there are no microscale features. In contrast, if an electroactive surface had microscale protrusions with a combined surface area of the top surface of the microscale protrusions that was half the surface area of the electroactive surface if there were no microscale features, the solid fraction would be 0.5. Additionally, if that same textured surface had nanoscale protrusions on top of the microscale protrusions, those nanoscale protrusions would be considered the top surface of the microscale protrusions. Accordingly, if the combined surface area of the top surface of the nanoscale features was half the combined surface area of the top surface of the microscale protrusions without any nanoscale protrusions, the solid fraction would be 0.25 (half what it was without the nanoscale protrusions). From this example, it can be seen that nanoscale features may reduce the solid fraction when used in combination with microscale features, but nanoscale features used alone are not considered in determining solid fraction.

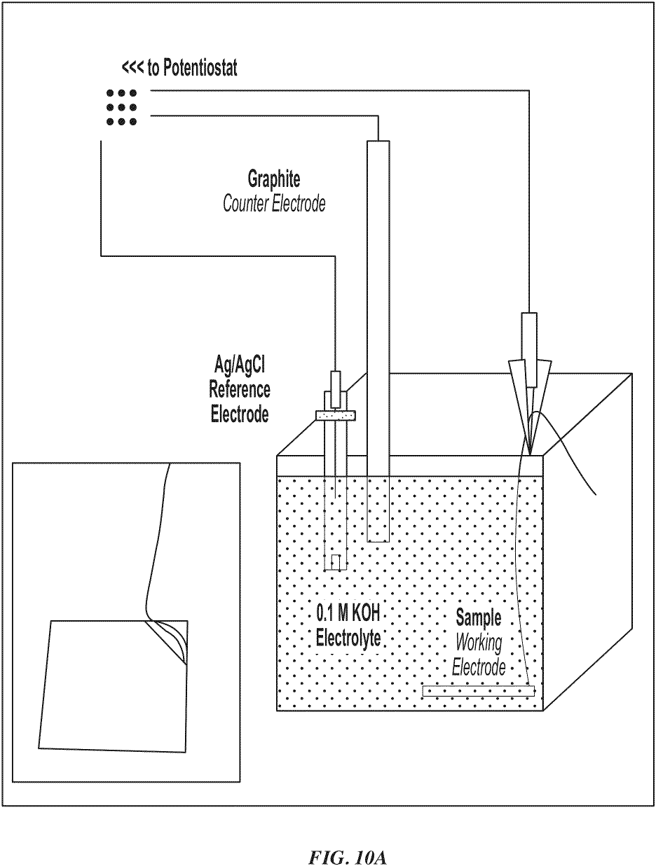

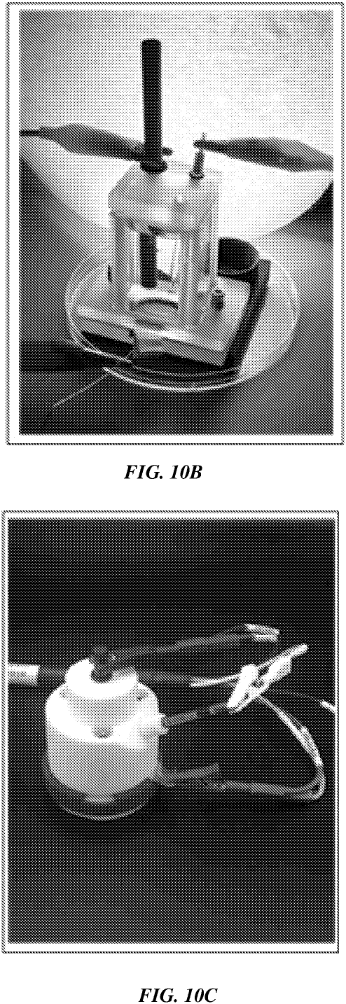

As another example, in accordance with some embodiments, in FIGS. 3D and 3E, the rectangular boxes represent the surface area of the top surface of the microscale protrusions. In this example, surface area 165 of the top surface of microscale protrusions 125 is larger in FIG. 3D than it is in FIG. 3E. However, the surface area of electroactive surface 110 if there were no microscale features is the same in both cases. Accordingly, the solid fraction of FIG. 3D is larger than that of FIG. 3E. For example, if the surface area of the electroactive surface if there were no microscale features was 100 microns in both FIG. 3D and FIG. 3E, and the surface area of the top surface of the microscale protrusions was 30 microns in FIG. 3D and 10 microns in FIG. 3E, then FIG. 3D would have a solid fraction of 0.3 while FIG. 3E would have a solid fraction of 0.1.

The solid fraction may be measured using a variety of available profilometry techniques (e.g., optical profilometry, mechanical profilometry, atomic force microscopy). In the case of microscale protrusions having square tops and uniform spacing, the solid fraction can be determined based on the following equation:

$$∅ = \frac{{a}^{2}}{{\left(a + b\right)}^{2}} \qquad \text{(Equation 1)}$$

wherein a is the smallest cross-sectional dimension of the solid portions (e.g., the microscale protrusion) and b is the spacing between the solid portions.

In some embodiments, the surface texture comprising a plurality of microscale protrusions has a solid fraction of greater than 0, greater than or equal to 0.0001, greater than or equal to 0.001, greater than or equal to 0.01, greater than or equal to 0.03, greater than or equal to 0.05, or greater than or equal to 0.07. In certain cases, the surface texture comprising a plurality of microscale protrusions has a solid fraction of less than or equal to 0.5, less than or equal to 0.4, less than or equal to 0.3, less than or equal to 0.2, or less than or equal to 0.1. Combinations of these ranges are also possible (e.g., greater than 0 and less than or equal to 0.5 or greater than 0 and less than or equal to 0.1). In some embodiments, the solid fraction of the microscale protrusions are pinning sites for the growth of bubbles, such that having a smaller solid fraction results in a reduced median bubble size.

In certain embodiments, the surface texture comprises a plurality of microscale indentations. For example, in accordance with some embodiments, surface texture 120 in FIG. 3G comprises microscale indentations 125. In some embodiments, the microscale indentations are uniform. In certain cases, the microscale indentations are not uniform.

The microscale indentations may have a variety of suitable shapes, in some cases. Non-limiting examples of suitable shapes for microscale indentations are shown in FIG. 3F. In some embodiments, the electroactive surface defines the XY-plane. In solid black, FIG. 3F shows a cross-section in the XY-plane of examples of suitable shapes. For example, FIG. 3F shows cross-sections in the XY-plane in the shape of (from left to right): a circle, a triangle, a square, a rectangle, and a star. In some embodiments, convex geometries (e.g., a star) reduce pinning distances, resulting in a reduction in median bubble size and/or the total surface area of the electroactive surface covered by bubbles.

In certain embodiments, the microscale indentations have a smallest cross-sectional dimension within a particular range. The microscale indentations may also have a height within a particular range. As used herein, the smallest cross-sectional dimension of a microscale indentation is the smallest dimension of the microscale indentation in a direction parallel to the surface into which the microscale indentation extends (i.e., the smallest dimension in a direction in the XY-plane, as illustrated in the figures) measured through the geometric center of the section being measured (which may or may not be the geometric center of the indentation as a whole). Also, as used herein, the height of a microscale indentation corresponds to the largest cross-sectional dimension in a direction perpendicular to the surface into which the microscale indentation extends (i.e., the largest cross-sectional dimension of the microscale indentation in the Z-direction, as illustrated in the figures, where the Z-direction is perpendicular to the XY plane). Accordingly, the height cannot be the smallest cross-sectional dimension. For example, in accordance with certain embodiments, microscale indentations 175 in FIG. 3G have smallest cross-sectional dimension 145 in the XY-plane, while microscale indentations 175 in FIG. 3H have height 135 in the Z-direction. In some embodiments, the height of the microscale indentations is uniform. In certain cases, the height of the microscale indentations is not uniform. In certain embodiments, an increase in height can lead to increased electrochemical output (e.g., if the microscale indentation is coated in a catalyst) because it increases surface area. The arrows in FIG. 3F demonstrate the smallest cross-sectional dimensions for various shapes.

In certain instances, the smallest cross-sectional dimension of the microscale indentations is uniform. In some embodiments, the smallest cross-sectional dimension of the microscale indentations is not uniform. In certain embodiments, the microscale indentations have a median smallest cross-sectional dimension of less than or equal to 1.0 times, less than or equal to 0.9 times, less than or equal to 0.8 times, less than or equal to 0.7 times, or less than or equal to 0.6 times the median bubble size produced during use in an otherwise identical system without the microscale indentations. In some embodiments, the microscale indentations have a median smallest cross-sectional dimension of greater than or equal to 0.1 times, greater than or equal to 0.2 times, greater than or equal to 0.3 times, or greater than or equal to 0.4 times the median bubble size produced during use in an otherwise identical system without the microscale indentations. Combinations of these ranges are also possible (e.g., greater than or equal to 0.1 times the median bubble size produced during use in an otherwise identical system without the microscale indentations and less than or equal to the median bubble size produced during use in an otherwise identical system without the microscale indentations).

In some cases, the microscale indentations have a median smallest cross-sectional dimension of less than or equal to 1,000 microns, less than or equal to 800 microns, less than or equal to 600 microns, less than or equal to 400 microns, less than or equal to 200 microns, or less than or equal to 100 microns. In certain instances, the microscale indentations have a median smallest cross-sectional dimension of greater than or equal to 1 micron, greater than or equal to 2 microns, greater than or equal to 4 microns, greater than or equal to 6 microns, greater than or equal to 8 microns, or greater than or equal to 10 microns. Combinations of these ranges are also possible (e.g., greater than or equal to 1 micron and less than or equal to 1,000 microns or greater than or equal to 10 microns and less than or equal to 100 microns).

In some embodiments, the solid electroactive surface portions above the microscale indentations are pinning sites for the growth of bubbles, and if the median smallest cross-sectional dimension of the microscale indentations is too small, multiple solid electroactive surface portions may act as pinning sites for the same bubble, resulting in increased bubble size than if the median smallest cross-sectional dimension of the microscale indentations were larger. However, if the median smallest cross-sectional dimension of the microscale indentations is too large, the microscale indentations themselves may serve as pinning sites for bubbles, resulting in increased bubble size than if the median smallest cross-sectional dimension of the microscale indentations were smaller.

Generally, the microscale indentations have spacing between them. For example, in accordance with certain embodiments, microscale indentations 175 in FIG. 3G have spacing 155 between them. Similarly, in accordance with some embodiments, microscale indentations 175 in FIG. 3H have spacing 155 between them. In some instances, the spacing between the microscale indentations is uniform. In certain cases, the spacing between the microscale indentations is not uniform.

In some embodiments, the median spacing between the microscale indentations is less than or equal to 1.0 times, less than or equal to 0.9 times, less than or equal to 0.8 times, less than or equal to 0.7 times, or less than or equal to 0.6 times the median bubble size produced during use in an otherwise identical system without the microscale indentations. In some embodiments, the median spacing between the microscale indentations is greater than or equal to 0.1 times, greater than or equal to 0.2 times, greater than or equal to 0.3 times, or greater than or equal to 0.4 times the median bubble size produced during use in an otherwise identical system without the microscale indentations. Combinations of these ranges are also possible (e.g., greater than or equal to 0.1 times the median bubble size produced during use in an otherwise identical system without the microscale indentations and less than or equal to the median bubble size produced during use in an otherwise identical system without the microscale indentations).

In some cases, the median spacing between the microscale indentations is less than or equal to 1,000 microns, less than or equal to 800 microns, less than or equal to 600 microns, less than or equal to 400 microns, less than or equal to 200 microns, or less than or equal to 100 microns. In certain instances, the median spacing between the microscale indentations is greater than or equal to 1 micron, greater than or equal to 2 microns, greater than or equal to 4 microns, greater than or equal to 6 microns, greater than or equal to 8 microns, or greater than or equal to 10 microns. Combinations of these ranges are also possible (e.g., greater than or equal to 1 micron and less than or equal to 1,000 microns or greater than or equal to 10 microns and less than or equal to 100 microns).

In certain embodiments, if the median spacing between the microscale indentations is too large, the solid portions of the electroactive surface can serve as pinning sites, such that bubbles can grow larger in size than if the microscale indentations had a smaller spacing.

In some embodiments, the microscale indentations are coated with a catalyst (e.g., for the desired electrochemical reaction). In certain embodiments, the smaller the median spacing between the microscale indentations, the more catalyst will be present, resulting in increased electrochemical output.

In certain embodiments, the surface texture comprising a plurality of microscale indentations has a solid fraction within a particular range. As discussed above, the solid fraction (Ø) is the combined surface area of the top surface of all microscale features divided by the surface area of the electroactive surface if there were no microscale features and it was flat. In the case of microscale protrusions, the combined surface area of the top surface of all microscale features is the combined surface area of the top surface of all of the microscale protrusions. In the case of microscale indentations, the combined surface area of the top surface of all microscale features is the combined surface area of the electroactive surface that is not occupied by the microscale indentations. For example, if an electroactive surface had nanoscale indentations, but no microscale features, then the solid fraction would be 1, because there are no microscale features, so the combined surface area of the top surface of all microscale features is considered equivalent to the surface area of the electroactive surface if there were no microscale features. In contrast, if an electroactive surface had microscale indentations with a combined surface area of the top surface of the electroactive surface that was half the surface area of the electroactive surface if there were no microscale features, the solid fraction would be 0.5. Additionally, if that same textured surface had nanoscale indentations on top of the electroactive surface, the top surface of the electroactive surface would be considered the top surface of all microscale features. Accordingly, if the combined surface area of the top surface of the electroactive surface was half the combined surface area of the top surface of the electroactive surface without any nanoscale indentations, the solid fraction would be 0.25 (half what it was without the nanoscale indentations). However, if that same textured surface had nanoscale features (e.g., indentations) on the microscale indentations instead of on the top surface of the electroactive surface, the top surface of the electroactive surface would be considered the top surface of all microscale features, and the solid fraction would still be 0.5. From these examples, it can be seen that nanoscale features may or may not reduce the solid fraction when used in combination with microscale features, but nanoscale features used alone are not considered in determining solid fraction.

As another example, in accordance with some embodiments, in FIGS. 3I and 3J, the rectangular boxes represent the top surface area of the electroactive surface. In this example, surface area 165 of the top surface of electroactive surface 110 is larger in FIG. 3I than it is in FIG. 3J. However, the surface area of electroactive surface 110 if there were no microscale indentations is the same in both cases. Accordingly, the solid fraction of FIG. 3I is larger than that of FIG. 3J. For example, if the surface area of the electroactive surface if there were no microscale indentations was 100 microns in both FIG. 3I and FIG. 3J, the surface area of the top surface of the electroactive surface was 30 microns in FIG. 3I and 10 microns in FIG. 3J, then FIG. 3I would have a solid fraction of 0.3 while FIG. 3J would have a solid fraction of 0.1.

In some embodiments, the surface texture comprising a plurality of microscale indentations has a solid fraction of greater than 0, greater than or equal to 0.01, greater than or equal to 0.03, greater than or equal to 0.05, or greater than or equal to 0.07. In certain cases, the surface texture comprising a plurality of microscale indentations has a solid fraction of less than or equal to 0.5, less than or equal to 0.4, less than or equal to 0.3, less than or equal to 0.2, or less than or equal to 0.1. Combinations of these ranges are also possible (e.g., greater than 0 and less than or equal to 0.5 or greater than 0 and less than or equal to 0.1). In some embodiments, the solid portions of the electroactive surface above the microscale indentations are pinning sites for the growth of bubbles, such that having a smaller solid fraction results in a reduced median bubble size.

For both microscale indentation and microscale protrusions, the surface roughness (r) is the total surface area of the solid portions (e.g., the microscale protrusion, or the electroactive surface in the case of microscale indentations) divided by the surface area of the electroactive surface if there were no microscale features (e.g., microscale protrusions or microscale indentations). The surface roughness may be determined by optical profilometry. In cases where the surface texture comprises uniform square top protrusions or indentations that are uniformly spaced, the surface roughness can be determined based on the following equation:

$$r = \frac{{\left(a + b\right)}^{2} + 4 a h}{{\left(a + b\right)}^{2}} \qquad \text{(Equation 2)}$$

Some embodiments are related to electrochemical cells comprising one or more electroactive surfaces as described elsewhere herein.

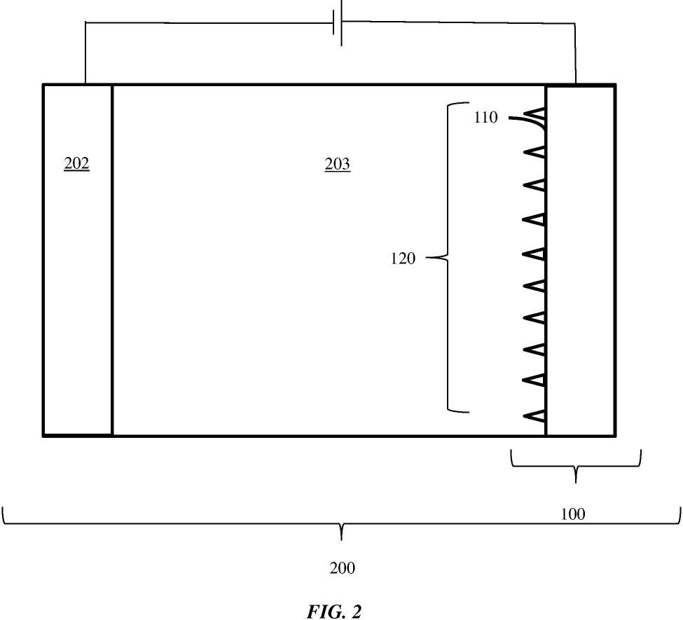

In some embodiments, the electrochemical cell comprises a first electrode. For example, in accordance with certain embodiments, electrochemical cell 200 in FIG. 2 comprises electrode 100 (e.g., first electrode). In some cases, the first electrode may be any electrode described herein.

In certain instances, the electrochemical cell comprises a second electrode. For example, in accordance with some embodiments, electrochemical cell 200 in FIG. 2 comprises additional electrode 202 (e.g., second electrode). In certain cases, the second electrode may be any electrode described herein.

In some embodiments, the electrochemical cell comprises a liquid electrolyte. For example, in accordance with certain embodiments, electrochemical cell in FIG. 2 comprises liquid electrolyte 203. Examples of suitable liquid electrolytes include any liquid medium capable of transmitting one or more ions to facilitate an electrochemical reaction. Examples of suitable liquid electrolytes include water, aqueous solutions, and/or non-aqueous solutions. Examples of non-aqueous solutions include solutions comprising a non-aqueous solvent and an electrolyte salt and/or solutions comprising an ionic liquid. Examples of aqueous solutions include solutions comprising water and an electrolyte salt. Non-limiting examples of electrolyte salts include Na₂SO₄, NaClO₄, NaNO₃, KOH, H₂SO₄, KHCO₃, and halide salts (e.g., halide anions (for example, F—, Cl—, Br—, I—) with corresponding cations (for example, Li+, Na+, K +, NH4+, Mg2+, Ca2+)). In certain cases, the liquid electrolyte is between the first electrode and the second electrode. For example, in some embodiments, liquid electrolyte 203 in FIG. 2 is in between electrode 100 (e.g., first electrode) and electrode 202 (e.g., second electrode).

In certain cases, at least one of the first electrode and the second electrode comprises an electroactive surface. For example, in certain embodiments, electrode 100 (e.g., first electrode) in FIG. 2 comprises electroactive surface 110. In some cases, the electroactive surface may be any electroactive surface described herein. In some embodiments, the electroactive surface comprises a surface texture. For example, in accordance with some embodiments, electroactive surface 110 in FIG. 2 comprises surface texture 120. In certain embodiments, the surface texture may be any surface texture described herein.

Certain aspects are related to methods. Some such methods can be understood in relation to FIGS. 1-3. In some embodiments, the method comprises running a reaction (e.g., a gas-generating reaction) within an electrochemical device and/or an electrode. In certain cases, the electrochemical device may be any electrochemical device described herein. In some instances, the electrode may be any electrode described herein. In certain embodiments, running a reaction comprises initiating a new reaction and/or maintaining an existing reaction. In certain instances, running a reaction comprises applying current to an electrode. In some embodiments, running a reaction comprises establishing and/or maintaining an electrical potential difference between a first electrode and a second electrode. For example, in accordance with certain embodiments, running a gas-generating reaction comprises establishing and/or maintaining an electrical potential difference between electrode 100 (e.g., first electrode) and additional electrode 202 (e.g., second electrode) in FIG. 2.

In some embodiments, the gas-generating reaction is an electrochemical reaction. Examples of electrochemical reactions include electrolysis reactions and chlor-alkali reactions. In certain instances, the gas-generating reaction generates hydrogen gas, chlorine gas, oxygen gas, carbon dioxide gas, carbon monoxide gas, methane gas, C₂H₂ gas, C₂H₄ gas, and/or C₂H₆ gas.

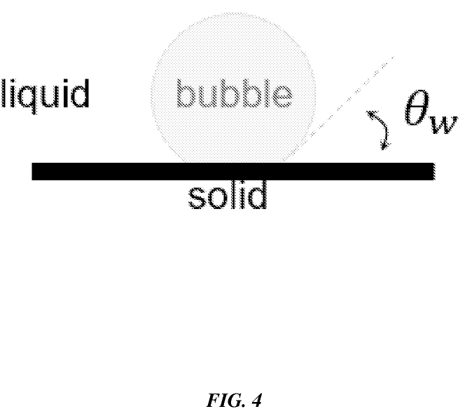

In some embodiments, a bubble is distinguished from gas layers trapped within texture or plastrons. In certain cases, a bubble satisfies the following equation:

$$c o s {θ}_{w} > - \frac{1 - ∅}{r - ∅} \qquad \text{(Equation 3)}$$

Where r is surface roughness (described above), ϕ is solid fraction (described above), and θ_{w} is the equilibrium contact angle of a bubble on a flat surface (θ_{w}) (e.g., an electroactive surface without microscale indentations or microscale protrusions), which is the angle measured through the liquid medium (e.g., liquid electrolyte) at the three phase contact line at the interface of the gas bubble, solid, and liquid (see FIG. 4).

In certain embodiments, the method comprises applying a voltage (e.g., applying an overpotential). In some embodiments, the overpotential is less than or equal to -1 mV, less than or equal to -25 mV, less than or equal to -50 mV, less than or equal to -70 mV, less than or equal to -85 mV, less than or equal to -100 mV, less than or equal to -125 mV, less than or equal to -150 mV, less than or equal to -175 mV, less than or equal to -200 mV, less than or equal to -225 mV, less than or equal to -250 mV, or less than or equal to -300 mV (vs RHE). In certain cases, the overpotential is greater than or equal to -400 mV, greater than or equal to -350 mV, greater than or equal to -300 mV, greater than or equal to -250 mV, greater than or equal to -200 mV, greater than or equal to -150 mV, or greater than or equal to -100 mV. Combinations of these ranges are also possible (e.g., less than or equal to -1 mV and greater than or equal to -400 mV).

In some embodiments, the articles, systems, and/or methods described herein are useful in electrolyzers (e.g., for hydrogen gas production, carbon dioxide electroreduction, and/or brine electrolysis), fuel cells, batteries, electroflotation separation processing, and/or electrochemical wastewater treatment reactors.

U.S. Provisional Pat. Application No. 63/034,013, filed Jun. 3, 2020, is hereby incorporated by reference in its entirety.

The following examples are intended to illustrate certain embodiments of the present invention, but do not exemplify the full scope of the invention.

### Example 1

This example demonstrates the use of a microtextured electrode to enhance the release of electrochemically generated bubbles from its surface. The electrodes in this example show that one can enhance the release of bubbles from the surface of the electrode by tailoring the geometry of the electrode’s surface, therefore enhancing the electrochemical output for a gas-evolving reaction. The electrodes described in this example employed a variety of microtextures to reduce bubble accumulation.

An objective of this example is to achieve more effective release of bubbles from the surface of electrodes. Since these bubbles tend to have a high affinity to adhere, their residence on the surface of the electrode causes inefficiencies both from a reaction standpoint, as well as an efficiency standpoint. Thus, an objective of this example is to move towards the realization of ‘bubble-free’ electrochemical catalyst materials by means of engineering the surface features of the material at the microscale to minimize the negative impacts evolved bubbles cause. More effective release of bubbles from the surface of electrodes may have a wide variety of applications, as the evolution of gas at an electrochemical electrode’s surface, either intentionally or unintentionally, is common within the field of electrochemistry (e.g., in the chlor-alkali process or in water electrolysis).

In electrochemical cells, bubbles first nucleate, grow, and finally depart from the surface. To predict the performance of real electrochemical devices, models and relations for the coverage of bubbles have been developed. In some embodiments, the choice of electrolyte, the geometry of the electrode, the physical properties of the electrode, the temperature, the pressure, and/or the applied potential can impact the nature of the electrochemical reaction, and thus the nature of the bubble generation.

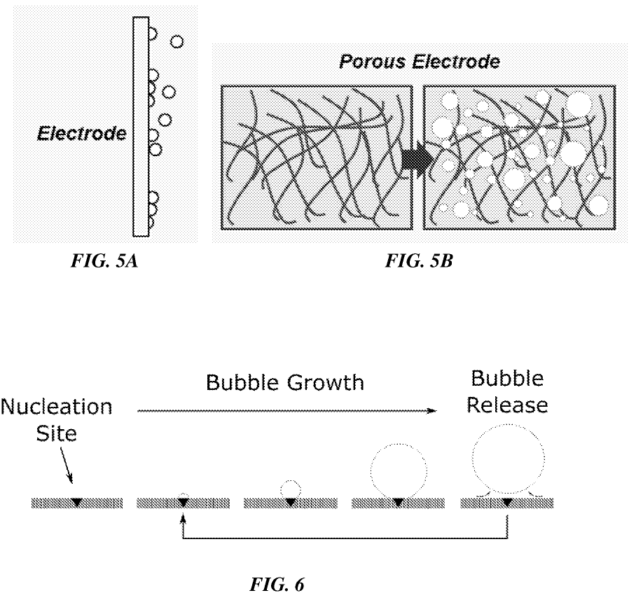

Inactivation of an electrochemical process due to bubbles on the surface of electrodes could be limited by limiting the ability for bubbles to reside on the electrode material itself. This concept of getting the bubbles away from the electrode’s surface as quickly as possible could be advantageous for next generation catalyst materials that are porous with ultra-high specific surface areas, as bubbles can get trapped within the porous 3D geometries (see FIGS. 5A-5B). Therefore, efficiently transporting bubbles from these porous electrodes can limit the level of flooding of the active catalyst area.

Moreover, this example demonstrates the reduction of bubbles from electrode surfaces by solely modifying the geometry of the electrode’s surface at the microscale, while preserving the chemistry of the electrode (e.g., without coatings or surface modifications that would impact the catalytic benefits and possibly the conductivity of the electrode).

Additionally, this example demonstrates the use of microtexture to enhance electrochemical output. This example further demonstrates the use of a microtexture to maximize the specific current density delivered while minimizing the amount of catalyst material.

### Electrochemical Bubble Generation

This example considered nucleate gas evolution from the electrode surface. In nucleate gas evolution, gas bubbles are formed at nucleation sites, and then continue to grow until a critical size at which time they depart from the electrode’s surface, as depicted in FIG. 6. In the case of a relatively stagnant electrolyte with the surface of the electrode pointing upwards, as was the case for all experiments in this example, as forced convection or active mixing is not prescribed, the dominant force that removes the adhered bubbles from the electrode surface is buoyancy. The forces involved between the electrode and the bubble will be discussed in more detail below.

The actual nucleation site is typically affected by defects on the surface (e.g., a small cavity). Any preexisting or trapped gas at the surface will also serve as an initiator for the nucleation of a gas bubble, so bubbles may continuously form from the same nucleation sites, as a small amount of residual gas left at the site will serve as the initiator for the next bubble from the site. For real surfaces, the heterogeneity of the surface geometry (e.g., scratches or other imperfections) will also offer additional nucleation sites from an idealized, homogenous surface. Aside from the location of the site itself, the nucleation of a bubble also requires the bubble to be of a critical size, which is related to the interfacial properties of the particular gas and liquid, which will be discussed in more detail below.

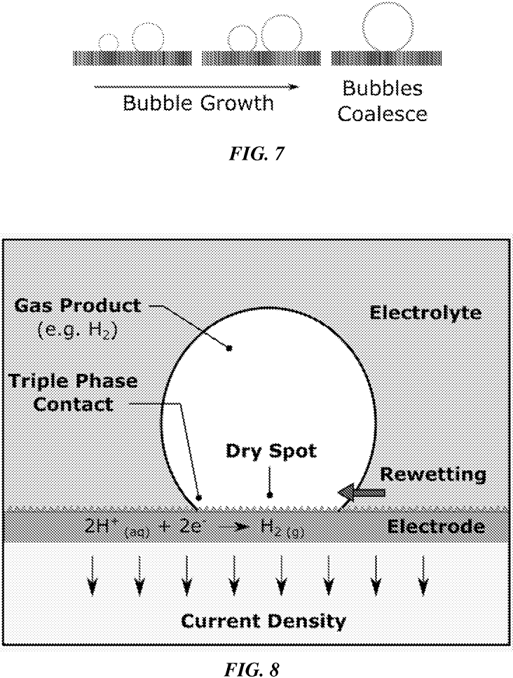

When sufficiently high current densities exist at gas-evolving electrodes, many nucleation sites are active and bubbles are prevalent enough on the surface that they have interactions with one another. As such, two neighboring nucleation sites’ bubbles could grow into one another, coalesce and continue to grow as a single bubble on the surface before departing, as shown in FIG. 7.

At the electrode’s surface, charge transfer occurs between species in the electrolyte and electrons at the electrode’s surface, thus completing an electrochemical reaction. In this example, the hydrogen evolution reaction was used, with the following half reaction at the cathode:

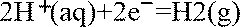

In this example, the oxygen evolution reaction was used, with the following half-reaction at the anode:

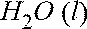

These two half reactions at the cathode and anode together make the overall electrochemical reaction of splitting water by electrolysis into hydrogen and oxygen gas, provided by the following reaction:

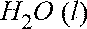

For all of the experiments described herein, the bubble generation that was studied and characterized was that of the hydrogen evolution reaction occurring at the cathode, which was a platinum working electrode in all cases.

### Electrochemical Experimental Methods

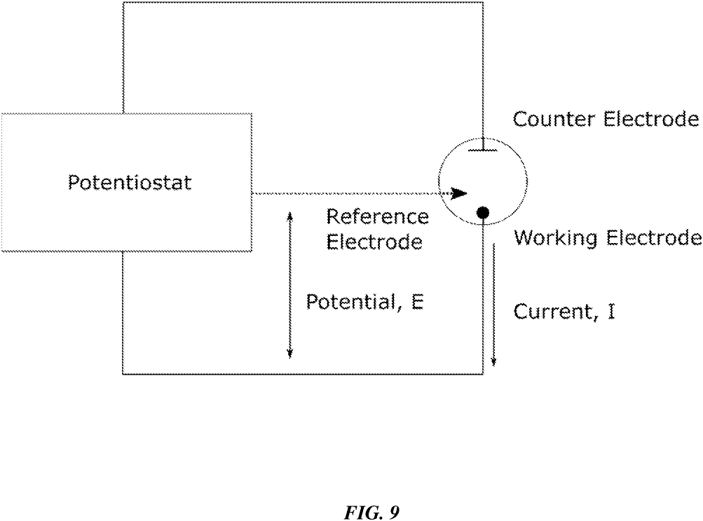

For all of the experiments in this example, the arrangement was a 3-electrode setup, as shown in FIG. 9.

Three different setups were constructed and used to collect data. FIGS. 10A-10C show schematics and photographs of the setups used.

For the electrochemical data collection, three different methods were employed: (1) chronoamperometry, (2) chronopotentiometry, and (3) cyclic voltammetry.

### Chronoamperometry

During a typical chronoamperometry experiment, the potential between the working electrode and reference electrode is controlled while the resulting current is measured, as shown in FIGS. 11A-11B. In this example, the potential was stepped to a constant value to evolve hydrogen gas at the working electrode’s surface and the resulting current was measured over time.

When the electrochemical reaction occurs under diffusion controlled conditions, the Cottrell Equation can typically be used to describe the current of the cell as a function of time:

$$i = \frac{n F A C \sqrt{D}}{\sqrt{t π}} \qquad \text{(Equation 4)}$$

In Equation 4, i is the current density, n is the number of electrons involved in the reaction, F is Faraday’s constant, A is the area of the electrode, C is the bulk concentration of the species of interest, D is the diffusivity of the species, and t is the time. However, the Cottrell Equation is not valid if the electrolyte-electrode interface is in motion, for example in an electrode that swells or grows over time. However, the behavior of the currents measured herein obeyed the general relationship as i decayed with

$$1 / \sqrt{t} .$$

### Chronopotentiometry

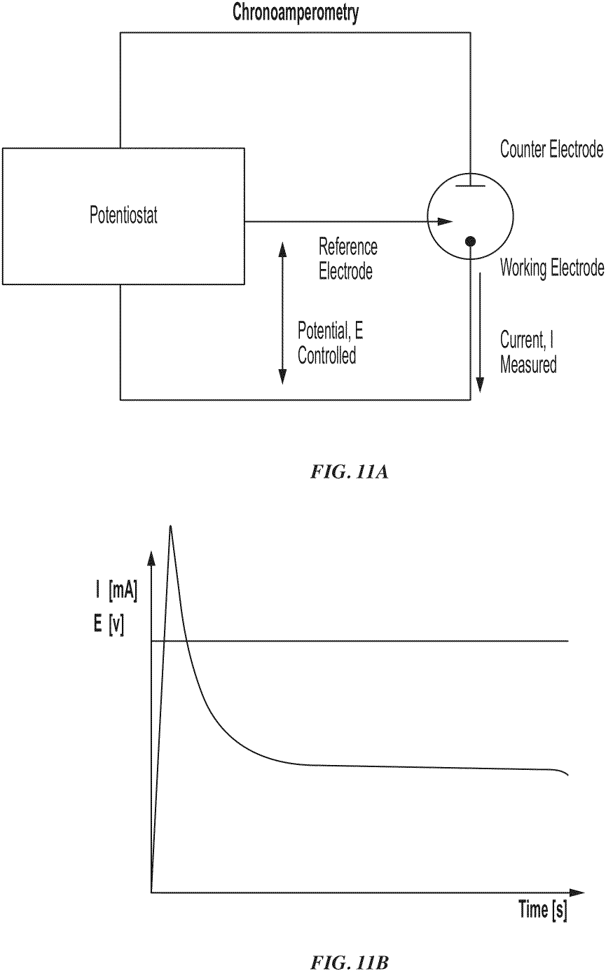

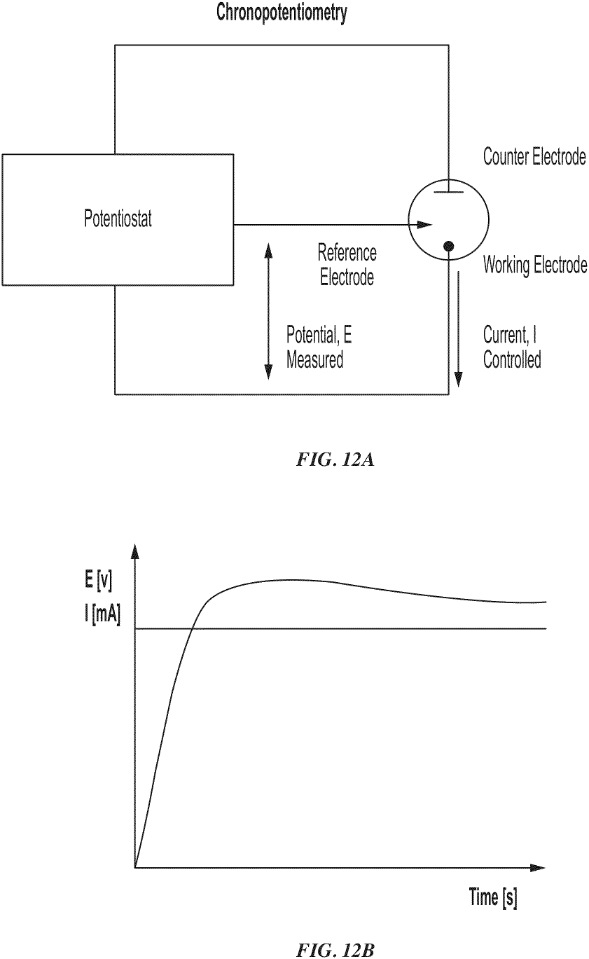

During a typical chronopotentiometry experiment, the current passed by the working electrode is controlled, forcing a resulting potential between the working and reference electrode to arise, which is measured as a function of time. This is shown schematically in FIGS. 12A-12B. In this example, a constant current density of 1 mA/cm² was applied for all chronoamperometry experiments.

Chronopotentiometry is commonly used as an analytical method for characterizing physical properties for an electrochemical system, like the value of the diffusivity of a particular species, or for determining the concentration of a specific electrochemically active species in solution. Additionally, chronopotentiometry can be used to study mechanisms that are occurring at an electrode by studying the relationship between the arising potential E over time give an applied current density i.

### Cyclic Voltammetry

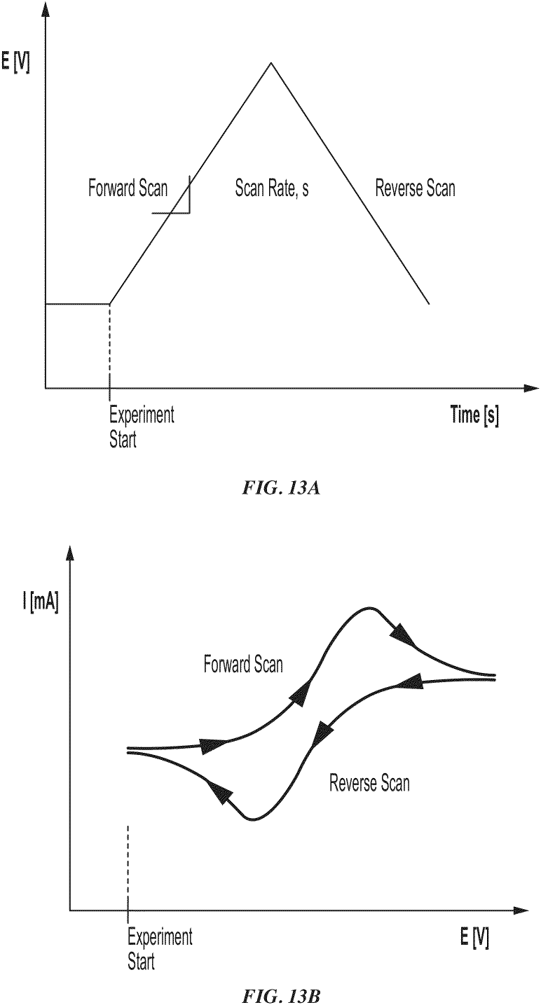

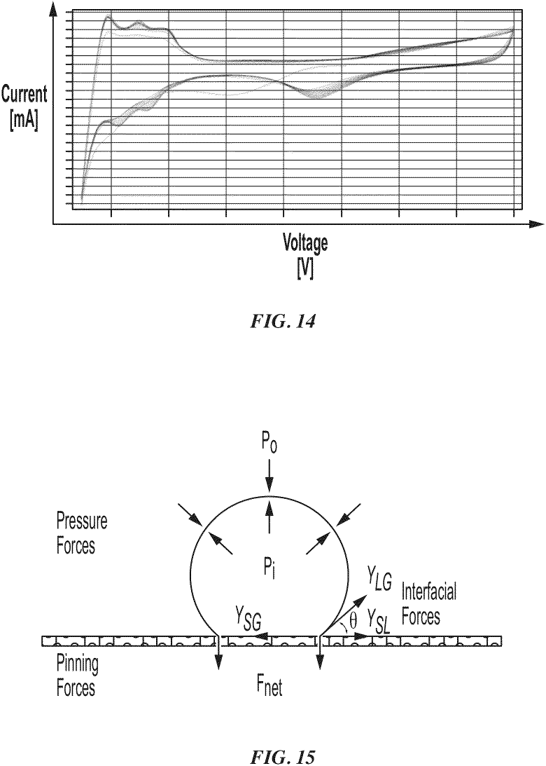

Cyclic Voltammetry experiments involve sweeping the potential across a range of values, typically repeating this sweeping over a number of cycles. In this example, only one type of cyclic voltammetry experiment was conducted: linear potential sweep chronoamperometry, or more commonly referred to as linear sweep voltammetry. In linear sweep voltammetry, the potential is linearly changed at the working electrode relative to the reference electrode while recording the resulting current, as shown in FIGS. 13A-13B. A single cycle for this example involved ramping from a starting potential at a constant rate to a final potential, then decreasing back at the same rate to the starting potential. This cycling can then be repeated for a defined number of cycles. Typical cyclic voltammetry experiments are carried out for more than a single cycle. In this example, cyclic voltammetry was done repeating the linear potential sweep cycle 10 times. An illustrative example of the resulting cyclic voltammetry data collected from an experiment is shown in FIG. 14, where the multiple traces along the current voltage space represent multiple sweep cycles.

From a given experiment, the charge associated with a particular portion of the current voltage curve can be obtained from the following equation, integrating the charge passed between two points on the current voltage curve:

$$Q = {\int }_{{t}_{1}}^{{t}_{2}} I d t = \frac{1}{s} {\int }_{{E}_{1}}^{{E}_{2}} I d E \qquad \text{(Equation 5)}$$

In Equation 5, Q is the total charge, I is the current measured [A], s is the scan rate [V/s], E₁ and E₂ [V] are the values of potential over which are being integrated across.

The adsorption or desorption of species onto the surface of electrochemical catalyst materials can be used to determine useful properties of the catalyst material. In this example, the total charge that is transferred during underpotential deposition of hydrogen onto the surface of the platinum was measured, which follows the following reaction:

$$P t + {H}^{+} + {e}^{-} \to P t - {H}_{u p d}$$

The utilization of cyclic voltammetry for the investigation of the electrochemically active surface areas of various catalyst materials can be used to determine the area of the electrode that is participating in the electrochemical reaction. In this example, this method was used to determine the electrochemically active surface area, such that the current densities could be determined from the measured currents.

### Model Electrochemical System

The hydrogen evolution reaction on a platinum working electrode was used in this example, using a 3-elecrode setup. The experiments were conducted in two different reaction conditions, as outlined in Table 1, such that hydrogen evolution was studied in either basic or acidic conditions.

TABLE 1

Two electrochemical conditions used for experiments in this example

| | | |
|---|---|---|
| Electrolyte [Concentration] | Reference Electrode [Electrolyte] | Counter Electrode [Size] |
| Potassium Hydroxide, KOH [0.1 M] | Ag/AgCl [4 M KC1] | Graphite Rod [6mm Diameter] |
| Sulfuric Acid, H₂SO₄ [0.25 M] | Ag/AgCl [4 M KC1] | Platinum Wire [0.5 mm Diameter] |

### Texture Impact on Electrochemical Performance

### Interfacial Phenomena and Wettability

The effect of bubbles creates large inefficiencies for water electrolysis technologies, due to the ohmic overpotential introduced when bubbles cover a large surface area of the electrode. The ability for a bubble to preferentially adhere to the surface of a material is affected by the interfacial phenomena at the interface between the gas, electrode and electrolyte for any gas evolving electrochemical process. Especially at small scales, the interfacial forces that are involved at the interface between these three phases affects whether a bubble preferentially adheres to the solid surface or not. The wettability of a solid surface to a fluid can be affected by the solid’s surface roughness. In this example, the surface roughness of the electrode’s surface was manipulated at the microscale to alter capillary effects that occur at the interface between the gas bubble, liquid electrolyte, and solid electrode.

For a bubble submerged in a liquid and adhered to the surface of a solid, FIG. 15 shows the static force balance that exists when the bubble is at equilibrium. In this figure, γ_{SG}, γ_{SL}, and γ_{LG} are the surface tensions between the solid/gas, solid/liquid and liquid/solid phases, respectively. The value of the equilibrium contact angle, Θ, made at the interface is an indication of the wettability of the gas to the solid in this system. Making the gas more wetting to the solid surface would cause Θ to increase toward the perfectly gas wetting case of Θ → 180°. Conversely, making the gas less wetting to the surface would decrease Θ towards Θ → 0°, when it is perfectly non-wetting and doesn’t wet the surface of the electrode and remains perfectly spherical.

The forces acting on the bubble in this scenario are: (1) those arising from the pressure difference between the inside and outside of the gas bubble, and (2) those arising from surface tension at the interface, resulting in a net pinning force at the interface which holds the bubble adhered to the surface. For slowly evolving bubbles, a force balance can theoretically be used to predict the size of a bubble departing from the surface due to buoyant forces becoming large enough to make the bubble release upwards from the surface. However, at the relatively high rates of bubble evolution that are common in electrochemical bubble generation, the dynamics of the contact angle and contact line itself are more complex, making the real departure size for bubbles more complex to predict accurately.

### Young-Laplace Equation

The curvature of an interface can affect the required pressure difference on opposite sides of the curved interface. The Young-Laplace Equation, Equation 6, shows the relationship between the pressure inside and outside of a curved surface, like the interface of a spherical bubble of radius R:

$$Δ P = {γ}_{L G} \left(\frac{1}{{R}_{1}} + \frac{1}{{R}_{2}}\right) = \frac{2 {γ}_{L G}}{R} \qquad \text{(Equation 6)}$$

This relationship affects the critical size for a bubble of gas to nucleate within a liquid, according to homogeneous nucleation theory. According to homogeneous nucleation theory, for a bubble to form it must satisfy Equation 6, forcing the critical radius for a bubble to nucleate, R_{c}, to be:

$${R}_{c} = \frac{2 {γ}_{L G}}{Δ P} = \frac{2 {γ}_{L G}}{{P}_{G} - {P}_{L}} \qquad \text{(Equation 7)}$$

Where P_{G} and P_{L} are the values of the pressure in the gas bubble and in the liquid electrolyte, respectively. According to this theory, the radius of the bubble must remain larger than this critical value, otherwise the bubble will not be stable and would dissolve in the electrolyte. In this example, it was assumed that there was only a single gas within the bubble. With this assumption, the interfacial properties of the system would have a direct impact on the nucleation of gas bubbles on electrodes in electrochemical systems.

### Young Equation

As previously discussed, the contact angle made by the triple phase interface affects the dynamics. By making a horizontal force balance on the idealized bubble, as shown in FIG. 15, the Young Equation, Equation 8, can be derived and is shown below:

$$- {γ}_{L G} c o s \left(Θ\right) = {γ}_{S L} - {γ}_{S G} \qquad \text{(Equation 8)}$$

This relationship determines the relationship between the contact angle Θ and the resulting interfacial tensions between the three phases. This equation implicitly assumes the use of the equilibrium contact angle since it is a static force balance using FIG. 15. In reality, the surface of the solid is not perfectly flat and homogenous, but rather has a roughness that will cause for a variety of contact angles to be possible, especially when the interface is in motion, as it would be for the case of a growing bubble. In this case, the contact angle can assume a range of values for the contact angle between the advancing and the receding contact angle values. The advancing contact angle is the maximum value that the contact angle can assume and is physically the largest contact angle obtained before the contact line is de-pinned as the contact area is increased during wetting, for instance as the bubble grows in size. The receding contact angle is the minimum value that the contact angle can assume and is physically the smallest angle obtained before the contact line is de-pinned as the contact area decreases during de-wetting, for instance as the bubble shrinks in size. In these cases, the contact angle is defined relative to the gas phase, rather than to the liquid phase as depicted in FIG. 15. The difference between the advancing contact angle and the receding contact angle was defined as the contact angle hysteresis for the system and was a measure of contact line dynamics.

### Surface Energy & Pinning

Due to the surface energies of the interfaces, a nucleated bubble at an electrode’s surface may be adhered, or pinned, to its surface. The interfacial tensions, or surface energies per unit area, between the particular phases involved in the system affect the thermodynamic favorability for one state or another. The contact line for the bubbles studied in this example was not particularly dynamic, as the bubbles remained very spherical throughout their lifetime. However, it is likely that the microposts used to texture the surface of the electrodes in this example were pinning sites for the bubbles as they grew during experiments. While the approach taken in this example was to enhance the ability for the bubbles to release from the surface of the electrode using microtexture, the differences that may exist for the pinning forces between the systems are discussed below, although they were not studied.

### Rewetting Effects to Modify Release of Electrochemical Bubbles

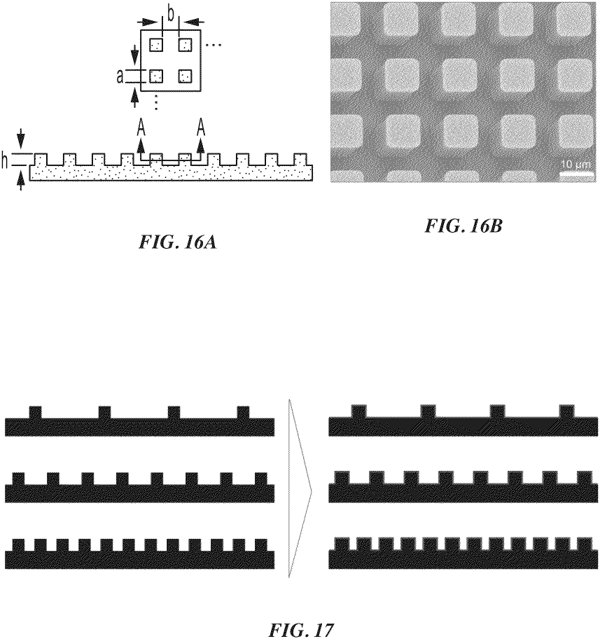

To modify the release of electrochemical bubbles from the surface of an electrode, lithography was used to pattern the surface of silicon wafers with arrays of microposts, as shown in FIGS. 16A-16B. The spacing between the microposts, b, was adjusted for experiments, leaving the geometry of each individual post constant. Changing the spacing between posts altered the surface capillarity experienced at the interface between the electrochemical bubbles, electrode and electrolyte.

A layer of platinum was sputter coated onto the surface of the micropost structures, such that the textures would be electrochemically active. This is schematically represented in FIG. 17, where a variety of textured surfaces were fabricated and then coated with a layer of platinum. The layers of platinum were not sputtered directly onto the patterned silicon substrates, due to the poor adhesion between silicon and platinum. Instead, a small adhesion layer of titanium was deposited between the silicon and platinum, approximately 10 nanometers in thickness. The thickness of the platinum layers sputtered on top of the textured surfaces was constant for all samples, -100 nanometers thick. Sputtering was chosen as the method for deposition of films so that the sides of posts would be uniformly covered, since the ballistic nature of sputter deposition can enable non-directional layer deposition so that all exposed areas of the microposts are uniformly covered, tops and sides.

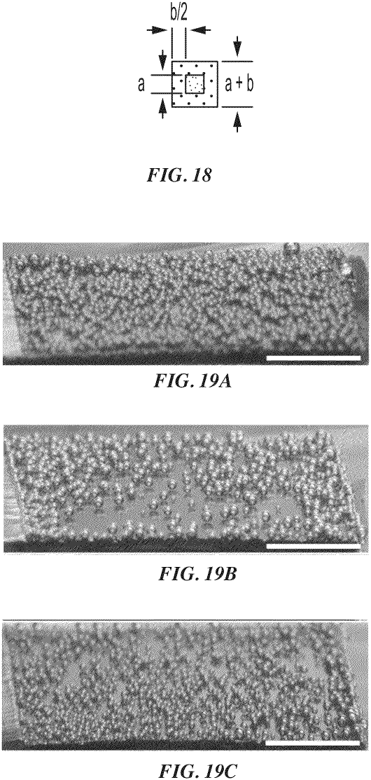

At the relatively small scale of the bubbles produced in this example, capillary surface rewetting could be used to release the bubbles from the surface of the electrode, meaning that the imbibition of electrolyte into the surface texture of the electrode due to the capillary pressure could be sufficient to cause fluid flow into the micropost arrays. An expression for the capillary pressure can be obtained by relating the change surface in surface energy arising from the liquid imbibing into a unit cell of the texture array, as shown in FIG. 18. For the unit cell, the volume of the fluid within the unit cell is V_{fluid} = h(b² + 2ab). Next, based on the surface tensions of the fluids involved, the energy change in the unit cell when the gas is replaced by liquid, ΔE, can be determined using Equation 9. The respective changes in surface energy for each phase were obtained by multiplying the relevant surface tension by the relevant surface area.

$$Δ E = \left({b}^{2} + 2 a b + 4 a h\right) \left({γ}_{S L} - {γ}_{S G}\right) + \left({b}^{2} + 2 a b\right) {γ}_{L G} \qquad \text{(Equation 9)}$$

To obtain the capillary pressure, the change in the surface energy of the unit cell can be divided by the change in volume of the fluid displaced during imbibition, resulting in Equation 10, using the Young Equation to relate the contact angle to the capillary pressure.

$${P}_{c} = - \frac{Δ E}{{V}_{f l u i d}} = \frac{\left({b}^{2} + 2 a b + 4 a h\right)}{h \left({b}^{2} + 2 a b\right)} {γ}_{L G} c o s \left(Θ\right) - \frac{{γ}_{L G}}{h} \qquad \text{(Equation 10)}$$

The liquid will then imbibe into the texture when the value of P_{c} < 0, which makes it energetically favorable for the electrolyte to rewet the electrode’s surface and displace the bubble. The pressure that opposes this capillary pressure and limits the imbibition of electrolyte is the viscous pressure drop that occurs as the fluid flows into the surface texture. This viscous pressure drop can be described by the following equation:

$${P}_{c} = \frac{μ v L}{K} \qquad \text{(Equation 11)}$$

Where µ is the electrolyte viscosity, υ is the velocity of the imbibing electrolyte front, L is the length that the electrolyte front moves, and K is the permeability of the surface texture. An expression for this geometry’s permeability treating the micropost array as a combination of flow through parallel flat plates and a free surface flow over a flat plate is as follows:

$$K = {\left[\frac{3}{{h}^{2}} + \frac{24 a \left(a + b\right)}{{b}^{2}}\right]}^{- 1} \qquad \text{(Equation 12)}$$

### Initial Observations & Considerations

Three working electrodes were fabricated for initial testing. For these initial tests, three spacings between posts were used: (1) 5 micron spacing between posts, (2) 10 micron spacing between posts, and (3) 25 micron spacing between posts.

The initial results of the bubble evolution from the three surfaces are summarized in FIGS. 19A-19C. The more densely packed microposts had densely packed bubbles adhered on the surface, occupying the majority of the surface area. Doubling the spacing between microposts from b = 5 µm to b = 10 µm resulted in a noticeable decrease in the coverage of the bubbles on the electrode’s surface. Additionally, the size of the bubbles also decreased. Finally, increasing the post spacing further from b = 10 µm to b = 25 µm between posts further decreased the size of the bubbles that were adhered to the surface. For these initial data points, as the texture density was decreased, the median size of a bubble when it was released from the surface was decreased and the coverage of the adhered bubbles on the electrode’s surface also decreased. A plot of the measured current density over time for these three cases showed that the resulting current density on the electrodes was higher for the case when the spacing was 25 microns, as shown in FIG. 20. These current densities were computed using the actual geometric area of the electrodes based on the micropost array dimensions and thus assumed that all the surface area of the electrodes participated in the electrochemical reaction.

### Electrochemical Bubble Analysis

### Electrochemically Active Surface Area Determination

As described in Section 2.3.3, cyclic voltammetry can be used to determine the relative area for a platinum electrode by measuring the total charge passed during the approximate window for hydrogen underpotential deposition. The purpose of these measurements was to confirm that for the scale of the textures involved in this example, all the geometric area of the catalyst would be available to participate in the reaction. These values for the electrochemically active surface areas were then used to normalize the measured currents to obtain the measured current densities.

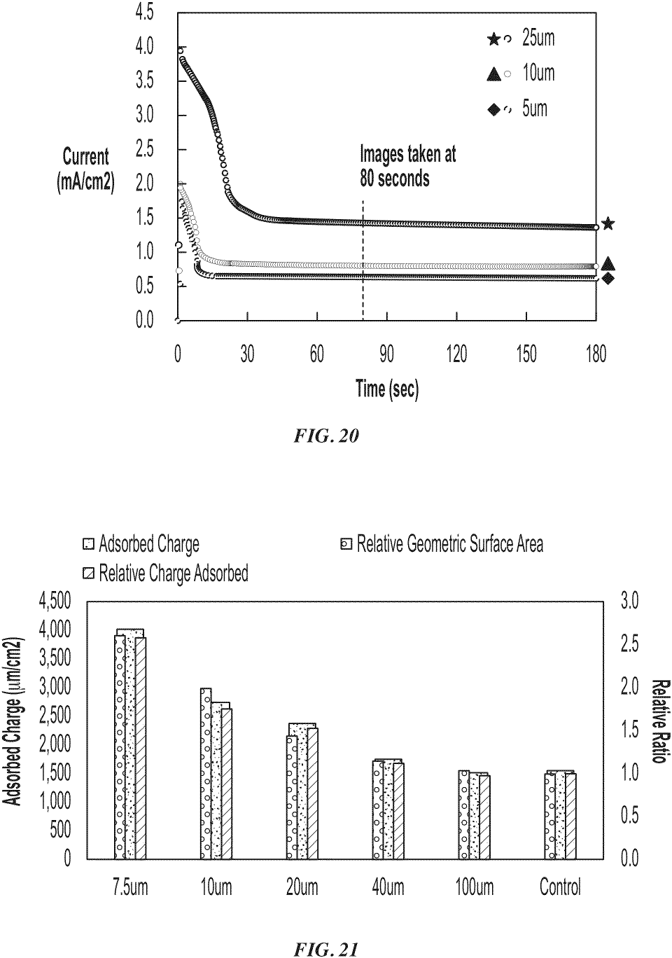

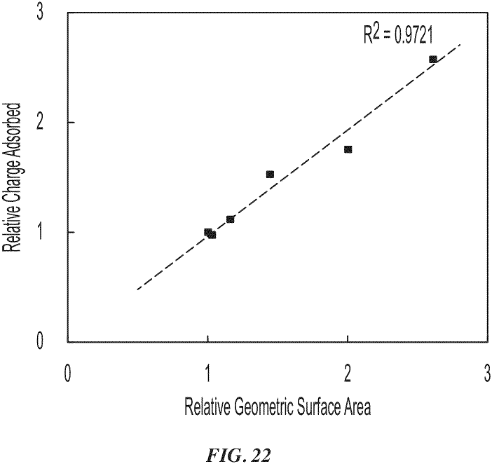

For a range of texture densities, varying the spacing b, a series of cyclic voltammetry experiments were conducted and analyzed to obtain the charge adsorbed onto the surface during underpotential deposition of hydrogen onto the platinum working electrode. The resulting data was summarized in FIG. 21. Note that the control case for all data points was the case where a flat silicon wafer is coated with platinum to compare as a baseline against the microtextured electrodes. As shown in FIG. 22, which plots the obtained relative ratio of the adsorbed charge, normalized by the charge obtained for the control case, against the relative geometric area ratio, also normalized by the control case, there was a strong correlation between these two values. This confirmed that the entire surface areas of the posts were participating in the electrochemical reaction at the surface of the electrode. For this reason, the current densities for the microtextured cases are reported based on using the geometric surface areas of the microposts, based on the design outlined earlier.

For the control case, the electrode area, defined by the o-ring seal that met the surface of the electrode in the experimental setup, and the current applied to obtain a current density of 1 mA/cm² are summarized in Table 2.

TABLE 2

Chronopotentiometry applied current used for control experiments

| Electrode Diameter [cm] | Electrode Area [cm2] | Current [mA] | Current Density [mA/cm²] |
|---|---|---|---|
| 0.607 | 0.289 | 0.289 | 1.000 |

By using the geometry of the micropost arrays, the surface areas for each texture density used were calculated. A comparison of the relative electrochemically active surface areas of the various micropost geometries used in this example is summarized in Table 3, which also includes the value of current required to obtain a current density equal to 1 mA/cm².

TABLE 3

Chronopotentiometry applied currents used for experiments

| Spacing, b [um] | Geometric Surface Area Factor (relative to control) | Current [mA] | Current Density [mA/cm²] |
|---|---|---|---|
| 5 um | 2.778 | 0.804 | 1.000 |
| 7.5 um | 2.608 | 0.755 | 1.000 |
| 10 um | 2.000 | 0.579 | 1.000 |
| 15 um | 1.640 | 0.475 | 1.000 |
| 20 um | 1.444 | 0.418 | 1.000 |
| 25 um | 1.327 | 0.384 | 1.000 |
| 40 um | 1.160 | 0.336 | 1.000 |
| 50 um | 1.111 | 0.322 | 1.000 |
| 100 um | 1.033 | 0.299 | 1.000 |
| Control | 1.000 | 0.289 | 1.000 |

This demonstrated that it would be possible to perform chronopotentiometry experiments, applying the same current density between different samples and comparing the resulting potential required to maintain these current densities.

### Altering Current Density Using Texture

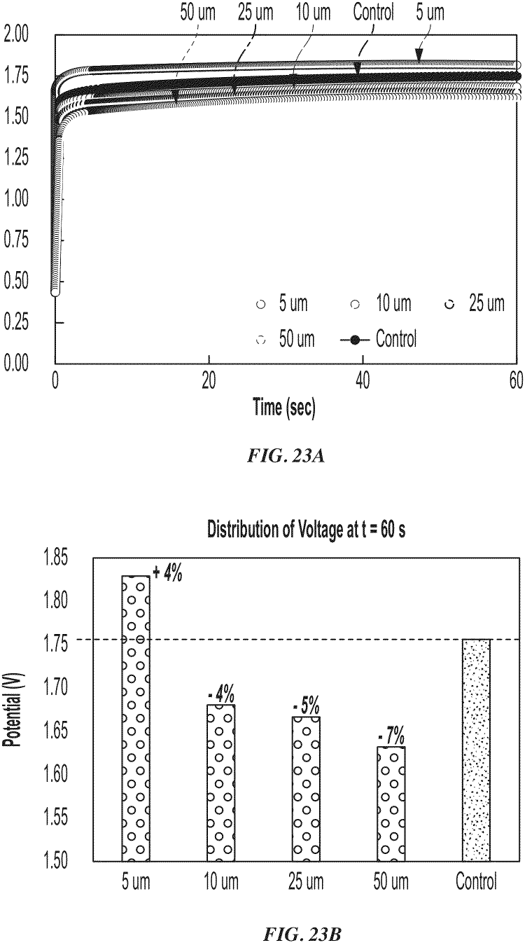

As shown in FIGS. 23A-23B, chronopotentiometry experiments were carried out for microtexture spacings of 5 microns, 10 microns, 25 microns, and 50 microns and then compared to the control case. The applied current used for each case was summarized in Table 3, which resulted in the same current density for each sample of 1 mA/cm². The potential required for the highest texture density, where b=5 um, required the largest potential, roughly 4% higher than that required for the control case. When the texture density was decreased from b=5 µm to less dense micropost spacings, the required potential decreased relative to the control case. For the case where b=5 µm, b=10 µm and b=25 µm, the required potential compared to the control case was decreased by 4%, 5%, and 7%, respectively. These results demonstrated that the efficiency for a cell to produce a desired current density can be improved by using microtexture on the electrode’s surface.

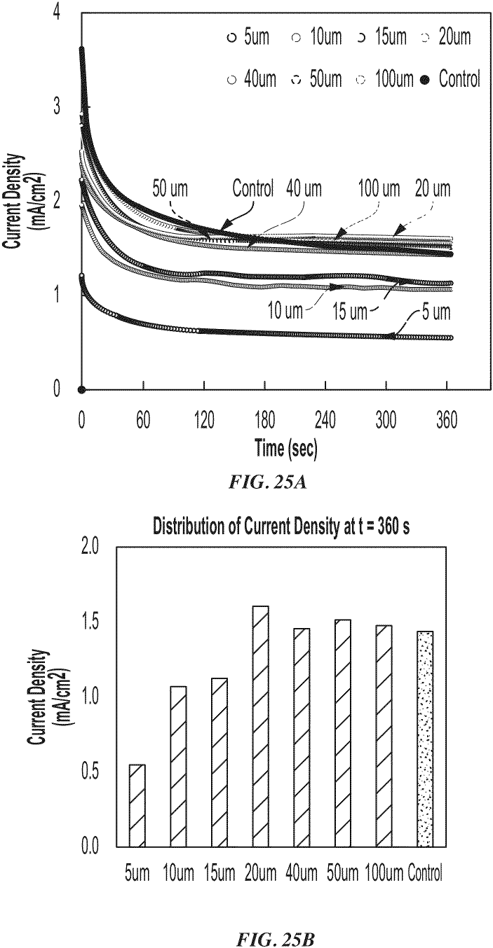

Next, chronoamperometry experiments were carried out to see the impact on the resulting current densities attainable by altering the microtexture of the electrode’s surface. As shown in FIGS. 25A-25B, chronoamperometry experiments were carried out for 360 seconds for b=5, 10, 15, 20, 30, 50 and 100 µm spacings as well as the control surface. The current density steadily increased as the spacing increased from b=5 µm to b=20 µm, where it became maximum. As the texture spacing was further increased towards the control case, the current density remained relatively constant.

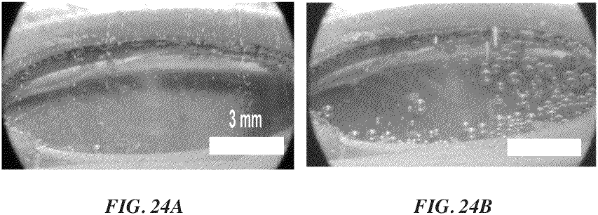

By looking at the evolution of bubbles from a side view of the electrode’s surface, as shown in FIGS. 24A-24B, the difference in the departing bubbles’ size and the coverage of adhered bubbles on the surface was evident. For the maximum current density when the spacing between posts was 20 µm, the bubbles departing the surface were much smaller in size than those departing the surface of the electrode when the spacing between posts was 5 µm. As smaller bubbles departing from the surface minimized the adverse effects that the adhered bubbles had on the current output, this enhanced release of bubbles from the electrode’s surface aligned with the improved current density. Conversely, the case where bubbles were adhering to the surface of the electrode most when b=5 µm also aligned to the worst current density performance of the textures tested.

### Bubble Generation Visualization

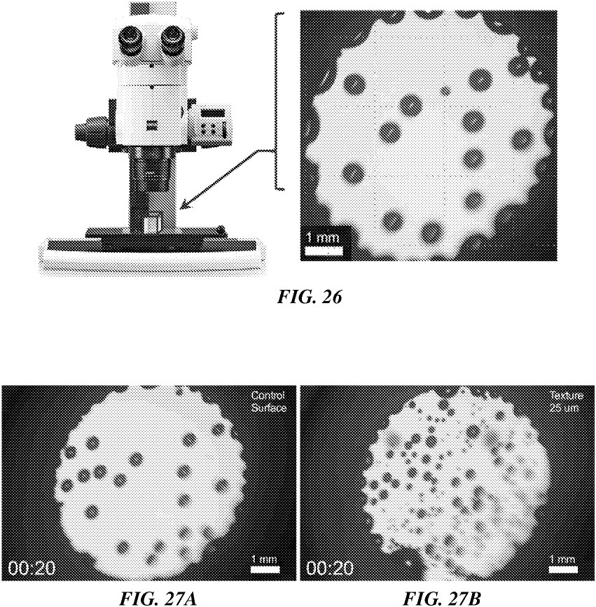

To observe the resulting bubbles from the electrode’s surface, a long working distance objective was used on a microscope to image the electrode’s surface from above. The experimental setup used for bubble visualization is shown in FIG. 26. The resulting images taken from above the electrode also confirmed that the bubble distribution across the electrode’s surface showed a smaller bubble size of adhered bubbles for the case when the microtexture spacing was b=25 µm as compared to the control case, when the bubbles were more uniform in size, all being larger. This comparison of the control surface bubble distribution versus the case when b=25 µm is shown in FIGS. 27A-27B.

This example demonstrated that the addition of microtexture to an electrode’s surface can help to promote capillary-driven rewetting of the electrolyte, to help and release the bubbles from the surface at a smaller size than otherwise would occur. This example demonstrated that altering the microtexture of the electrode’s surface can improve the electrochemical performance. Both chronoamperometry and chronopotentiometry experiments have demonstrated that using microtexture can help to increase the output of a gas-evolving electrode’s surface. This example demonstrates that altering the microtexture of an electrode’s service could be an effective passive method for improving the electrochemical output for a gas-evolving reaction.

### Methods

### Electrochemical Methods

All experiments were performed using a VSP potentiostat from BioLogic.

Chronoamperometry experiments were conducted using an applied potential of -1.1 V versus the Ag/AgCl reference electrode for all chronoamperometry experiments shown.

Chronopotentiometry experiments were conducted using an applied current density of 1 mA/cm², with the applied currents for particular texture densities and the control texture as previously listed in Table 2 and Table 3.

Cyclic voltammetry experiments were conducted with a scan rate of 100 mV/s, cycling between -0.3 V and 1.2 V vs Ag/AgCl reference electrode, repeating the cycle 10 times.

### Experimental Setups

Experimental setup used for initial experiments was a cubic quartz cuvette approximately 52 mm side lengths. Electrical connections from the working electrode were made by attaching stainless steel wire adhered to the electrode surface using conductive silver paint then covered in a conductive copper tape.

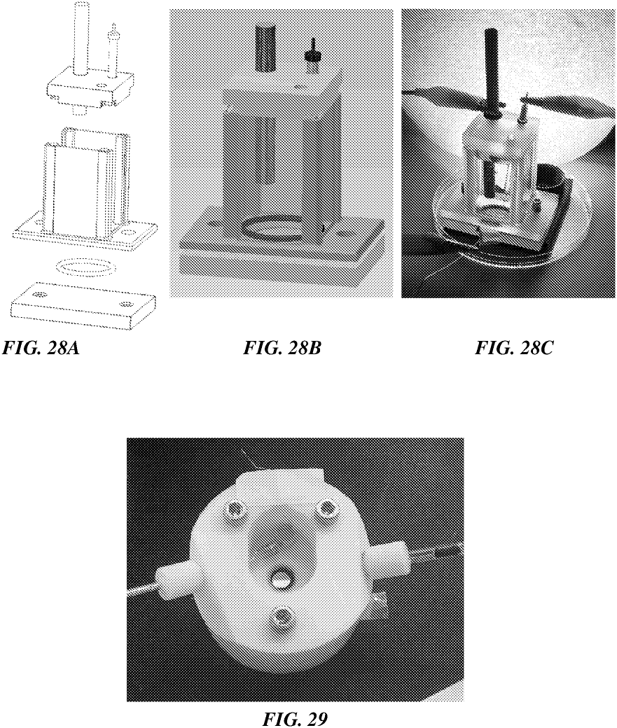

Electrochemical cell for visualizing the bubble experiments was fabricated using a Form 2 stereolithography 3D printer, using the clear UV curable resin. Glass cover slides were then adhered into slots using a chemically resistant epoxy. FIGS. 28A-28C show the model used to then print the cell for experiments. An o-ring was used to make a seal between the electrode’s surface and the cell.

Setup shown is used for cyclic voltammetry experiments as well as imaging of the electrode’s surface from above. This cell was fabricated from a Teflon rod to provide for excellent chemical resistance. Integrated counter and working electrodes also made imaging from above unobstructed, as shown in FIG. 29.

### Example 2

This example demonstrates the use of nanoscale features (e.g., nanograss) on electrodes. This example demonstrates that the use of microscale features on electrodes performs better than the use of nanograss features. However, this example also demonstrates that, in some cases, the combination of nanograss features with microscale features may perform better than either alone.

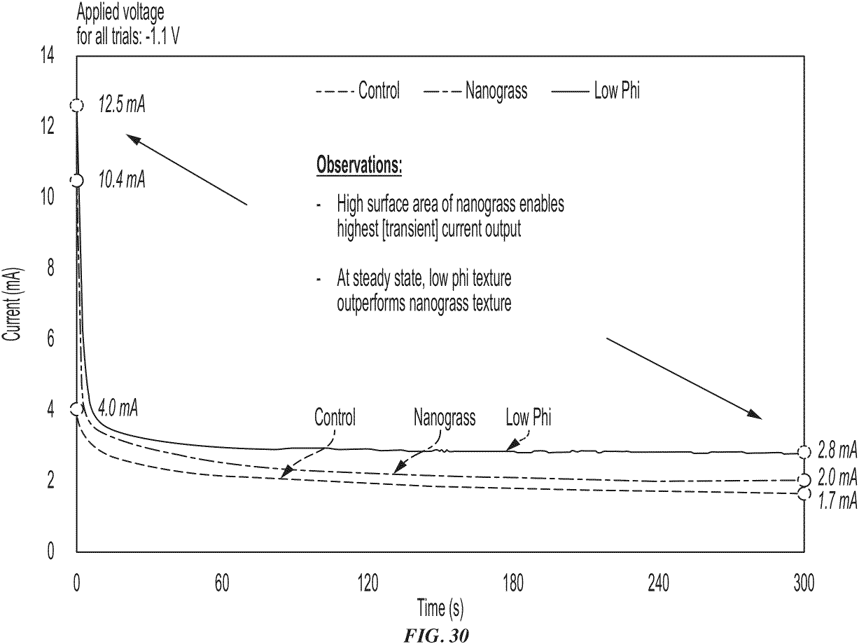

Three identical electrodes were made, except that they had a different surface texture on the electroactive surface of the electrode: a control electrode with no surface texture (“Control”), an electrode with a low solid fraction due to pyramidal microscale features (uniform smallest cross-sectional dimension of 10 microns and uniform spacing of 75 microns) (“Low Phi”), or an electrode with a high surface area of nanograss (“Nanograss”). The same electrochemical cell was tested, but switching between these electrodes as the working electrode. -1.1 V were applied to the electrochemical cell with each of these electrodes. As shown in FIG. 30, while the high surface area of the nanograss (which was coated with catalyst) had the highest (transient) current output, at steady state the low solid fraction was more important, resulting in a higher steady state current output for the electrode with the microscale features. As shown in FIG. 30, after 300 seconds, the electrode with microscale features had a current output of 2.8 mA, the electrode with the nanograss had a current output of 2.0 mA, and the control had a current output of 1.7 mA.

The effect of having both microscale features and nanoscale features (e.g., nanograss) on an electrode was then studied. The studies demonstrated increased current output for some electrodes with both microscale features and nanoscale features compared to identical electrodes with only the microscale features.

### Example 3

This example demonstrates the effect of surface texture on current output and current density.

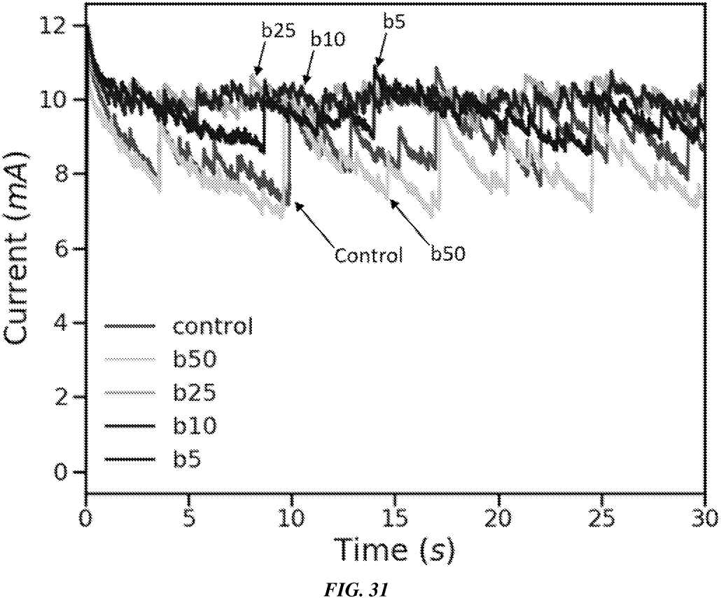

Five identical electrochemical electrodes were made, except that they had a different surface texture on the electroactive surface of the electrode: a control electrode with no surface texture (“control”), an electrode with microscale protrusions with a median spacing of 5 microns (“b5”), an electrode with microscale protrusions with a median spacing of 10 microns (“b10”), an electrode with microscale protrusions with a median spacing of 25 microns (“b25”), and an electrode with microscale protrusions with a median spacing of 50 microns (“b50”). An overpotential of -335 mV vs RHE was applied to each electrochemical electrode. As shown in FIG. 31, the current of the control fluctuated significantly, with current decreasing as the bubbles grew, and then suddenly increasing when the bubbles were released. As shown in FIG. 31, a similar effect was observed for b50. In contrast, the current output was more consistent and higher for b5, b10, and b25, particularly b10 and b25.

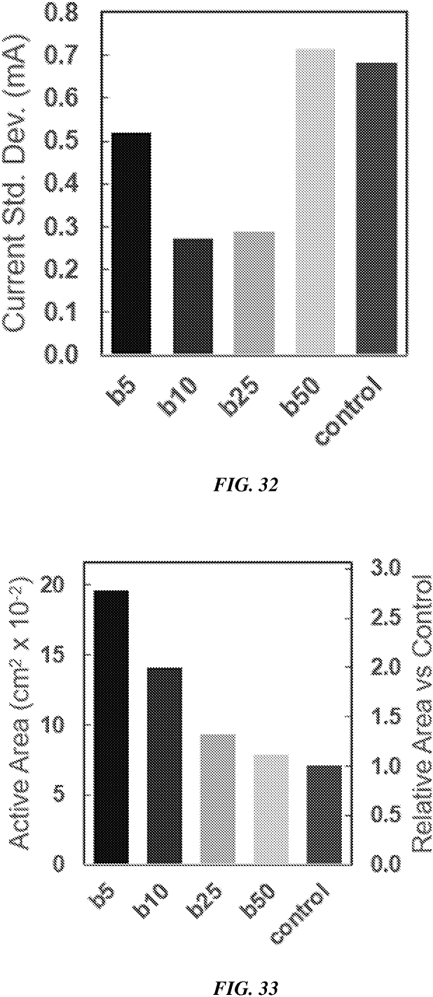

This can also be seen in FIG. 32, which shows the standard deviation in current output for the different electrochemical cells. As shown in FIG. 32, the highest standard deviation was shown in b50 and the control, while the standard deviation was reduced for b5, and was lowest for b10 and b25. This demonstrates that the median spacing of the surface texture should not be too large or too small in order to minimize the standard deviation in current output.

The surface textures with smallest median spacing had a higher surface area (and, thus, a higher active area, as the microscale protrusions were coated with catalyst), as shown in FIG. 33.

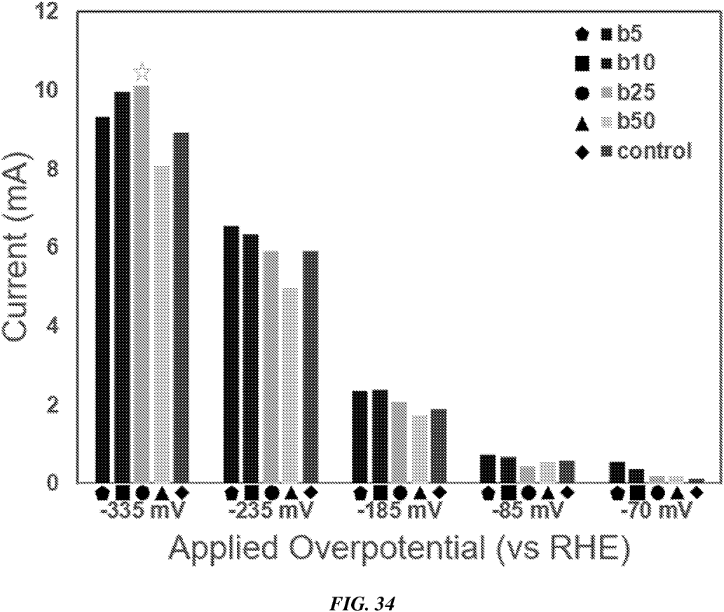

Overpotentials of -335 mV, -235 mV, -185 mV, -85 mV, and -70 mV (vs RHE) were then applied to the electrochemical electrodes. In FIG. 34, the average current output over 20 seconds is shown for each electrochemical electrode. FIG. 34 demonstrates that the microtexture that produced the greatest average current output depended on the applied overpotential. For example, b25 produced the highest average current at -335 mV, while b5 and b10 produced the highest average current at the other applied overpotentials.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

As used herein, a “micron” is a “micrometer.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An electrode, comprising:
an electroactive surface comprising a surface texture,
wherein the surface texture is configured such that, during a gas-generating reaction in a liquid medium adjacent to the electroactive surface, the median size of bubbles produced during the reaction and/or the total surface area of the electroactive surface covered by bubbles produced during the reaction are reduced relative to the median size of bubbles produced on an electrode lacking the surface texture but under otherwise identical conditions and/or the total surface area of the electroactive surface covered by bubbles produced on an electrode lacking the surface texture but under otherwise identical conditions.

2. An electrochemical device, comprising:
a first electrode;
a second electrode; and
a liquid electrolyte between the first electrode and the second electrode;
wherein at least one of the first electrode and the second electrode comprises an electroactive surface comprising a surface texture that reduces the median size of bubbles produced during a gas-generating reaction within the electrochemical device and/or reduces the total surface area of the electroactive surface covered by bubbles produced during a gas-generating reaction within the electrochemical device.

3. The electrode of claim 1, wherein the surface texture comprises a plurality of microscale protrusions.

4. The electrode of claim 3, wherein the median spacing between the microscale protrusions is greater than or equal to 0.05 times the median smallest cross-sectional dimension of the microscale protrusions.

5. (canceled)

6. The electrode of claim 4, wherein the median spacing between the microscale protrusions is less than or equal to 10 times the median smallest cross-sectional dimension of the microscale protrusions.

7. The electrode of claim 3, wherein the median spacing between the microscale protrusions is greater than or equal to 0.05 microns and less than or equal to 10,000 microns.

8. The electrode of claim 3, wherein the microscale protrusions have a median smallest cross-sectional dimension of less than or equal to the median bubble size produced during use in an otherwise identical system without the microscale protrusions.

9. The electrode of claim 3, wherein the microscale protrusions have a median smallest cross-sectional dimension of greater than or equal to 0.1 times the median bubble size produced during use in an otherwise identical system without the microscale protrusions and less than or equal to the median bubble size produced during use in an otherwise identical system without the microscale protrusions.

10. The electrode of claim 3, wherein the microscale protrusions have a median smallest cross-sectional dimension of greater than or equal to 1 micron and less than or equal to 1,000 microns.

11. (canceled)

12. The electrode of claim 3, wherein the textured surface has a median solid fraction of greater than 0 and less than or equal to 0.5.

13. (canceled)

14. The electrode of claim 3, wherein the microscale protrusions have a median height of greater than or equal to 0.1 times the median smallest cross-sectional dimension of the microscale protrusions and less than or equal to 10 times the median smallest cross-sectional dimension of the microscale protrusions.

15. (canceled)

16. The electrode of claim 3, wherein the microscale protrusions have a median height of greater than or equal to 1 micron and less than or equal to 1,000 microns.

17. The electrode of claim 1, wherein the surface texture comprises a plurality of microscale indentations.

18. The electrode of claim 17, wherein the microscale indentations have a median spacing of less than or equal to the median bubble size produced during use in an otherwise identical system without the microscale indentations.

19. The electrode of claim 17, wherein the microscale indentations have a median spacing of greater than or equal to 0.1 times the median bubble size produced during use in an otherwise identical system without the microscale indentations and less than or equal to the median bubble size produced during use in an otherwise identical system without the microscale indentations.

20. The electrode of claim 17, wherein the microscale indentations have a median spacing of greater than or equal to 1 micron and less than or equal to 1,000 microns.

21. (canceled)

22. The electrode of claim 17, wherein the microscale indentations have a median smallest cross-sectional dimension of less than or equal to the median bubble size produced during use in an otherwise identical system without the microscale indentations.

23. The electrode of claim 17, wherein the microscale indentations have a median smallest cross-sectional dimension of greater than or equal to 0.1 times the median bubble size produced during use in an otherwise identical system without the microscale indentations and less than or equal to the median bubble size produced during use in an otherwise identical system without the microscale indentations.

24. The electrode of claim 17, wherein the microscale indentations have a median smallest cross-sectional dimension of greater than or equal to 1 micron and less than or equal to 1,000 microns.

25. (canceled)

26. The electrode of claim 17, wherein the textured surface has a median solid fraction of greater than 0 and less than or equal to 0.5.

27. (canceled)

28. A method, comprising:
running a gas-generating reaction within an electrochemical device of claim 2 .

29. A method, comprising:
running a gas-generating reaction with an electrode of claim 1.

30-34. (canceled)
